(19) United States
(12) Patent Application Publication
(10) Pub. No.: US 2007/0165042 A1
(43) Pub. Date: Jul. 19, 2007

(54) Rendering apparatus which parallel-processes a plurality of pixels, and data transfer method

(76) Inventor: Seitaro Yagi, Kawasaki-shi (JP)

Correspondence Address: SPRINKLE IP LAW GROUP, 1301 W. 25TH STREET, SUITE 408, AUSTIN, TX, 78705, US

(21) Appl. No.: 11/644,200

(22) Filed: Dec. 22, 2006

(30) Foreign Application Priority Data
Dec. 26, 2005 (JP) 2005-371738
Dec. 26, 2005 (JP) 2005-371739
Dec. 26, 2005 (JP) 2005-371740

(51) Int. Cl. G06F 12/00

(52) U.S. Cl. 345/557; 711/118

(57) ABSTRACT

A rendering apparatus includes a memory device, a cache memory, a cache control unit and a rendering process. The memory device stores image data. The cache memory executes transmission/reception of the image data to/from the memory device. The cache memory includes a plurality of entries, each of which is capable of storing the image data. The cache control unit manages data transfer between the memory device and the cache memory and stores information relating to a state of the cache memory. The cache control unit stores, in association with each of the entries, identification information of the image data transferred from the memory device to the entry of the cache memory and transfer information which is indicative of whether the image data is already transferred to the entry or not. The rendering process unit executes image rendering by using the image data in the cache memory.

### CROSS-REFERENCE TO RELATED APPLICATIONS

This application is based upon and claims the benefit of priority from prior Japanese Patent Applications No. 2005-371738, filed Dec. 26, 2005; No. 2005-371739, filed Dec. 26, 2005; and No. 2005-371740, filed Dec. 26, 2005, the entire contents of all of which are incorporated herein by reference.

### BACKGROUND OF THE INVENTION

1. Field of the Invention

The present invention relates to a rendering apparatus which parallel-processes a plurality of pixels, and a data transfer method. For example, the present invention relates to an image processing LSI which simultaneously parallel-processes a plurality of pixels.

2. Description of the Related Art

In recent years, with an increase in operation speed of a CPU (Central Processing Unit), there has been an increasing demand for a higher operation speed of an image rendering apparatus.

In general, an image rendering apparatus includes a graphic decomposing means for decomposing an input graphic into pixels, pixel processing means for subjecting the pixels to a rendering process, and memory means for reading/writing a rendering result. In recent years, with development in CG (Computer Graphics) technology, complex pixel processing techniques have frequently been used. Consequently, a load on the pixel processing means increases. To cope with this, it has been proposed to construct the pixel processing means with a parallel architecture, as disclosed in U.S. Pat. No. 5,982,211, for instance.

### BRIEF SUMMARY OF THE INVENTION

A rendering apparatus according to aspect of the present invention includes:

a memory device which stores image data;

a cache memory which executes transmission/reception of the image data to/from the memory device, the cache memory including a plurality of entries, each of which is capable of storing the image data;

a cache control unit which manages data transfer between the memory device and the cache memory and stores information relating to a state of the cache memory, the cache control unit storing, in association with each of the entries, identification information of the image data transferred from the memory device to the entry of the cache memory and transfer information which is indicative of whether the image data is already transferred to the entry or not; and

a rendering process unit which executes image rendering by using the image data in the cache memory.

A data transfer method for a rendering apparatus including a memory device which stores image data; a cache memory which executes transmission/reception of the image data to/from the memory device; a cache control unit which includes identification information of the image data in the cache memory and manages data transfer between the memory device and the cache memory; and a rendering process unit which executes image rendering by using the image data in the cache memory, the method comprising:

causing, when data access to the cache memory is executed from the rendering process unit, the cache control unit to compare a content of the data access and the identification information;

causing, when the content of the data access agrees with the identification information, the cache control unit to determine whether the image data corresponding to the data access is stored in the cache memory;

executing the data access if the image data is stored, and halting the data access if the image data is not stored;

causing, when the content of the data access disagrees with the identification information, the cache control unit to rewrite the identification information to a content corresponding to the data access; and

causing, after the identification information is rewritten, the cache control unit to issue a transfer instruction to transfer the image data corresponding to the data access from the memory device to the cache memory.

### BRIEF DESCRIPTION OF THE SEVERAL VIEWS OF THE DRAWING

FIG. 1 is a block diagram of a graphic processor according to a first embodiment of the present invention;

FIG. 2 is a conceptual view of a frame buffer in the graphic processor according to the first embodiment of the present invention;

FIG. 3 is a conceptual view of the frame buffer in the graphic processor according to the first embodiment of the present invention;

FIG. 4 is a conceptual view of the frame buffer in the graphic processor according to the first embodiment of the present invention;

FIG. 5 is a conceptual view of the frame buffer in the graphic processor according to the first embodiment of the present invention;

FIG. 6 is a conceptual view of the frame buffer in the graphic processor according to the first embodiment of the present invention;

FIG. 7 is a conceptual view of a quad merge which is executed by the graphic processor according to the first embodiment of the present invention;

FIG. 8 is a conceptual view of an instruction sequence which is executed in the graphic processor according to the first embodiment of the present invention;

FIG. 9 is a timing chart showing states of sub-passes, which are executed in the graphic processor according to the first embodiment of the present invention;

FIG. 10 is a block diagram of a data control unit which is included in the graphic processor according to the first embodiment of the present invention;

FIG. 11 is a block diagram of the data control unit which is included in the graphic processor according to the first embodiment of the present invention;

FIG. 12 is a block diagram of an address generating unit which is included in the data control unit of the graphic processor according to the first embodiment of the present invention;

FIG. 13 is a conceptual view of an address signal which is generated by the address generating unit that is included in the data control unit of the graphic processor according to the first embodiment of the present invention;

FIG. 14 is a conceptual view of an address signal which is generated by the address generating unit that is included in the data control unit of the graphic processor according to the first embodiment of the present invention;

FIG. 15 is a block diagram of a cache memory which is included in the data control unit of the graphic processor according to the first embodiment of the present invention;

FIG. 16 is a block diagram of a request issuance control unit which is included in the data control unit of the graphic processor according to the first embodiment of the present invention;

FIG. 17 is a block diagram of a cache access control unit which is included in the data control unit of the graphic processor according to the first embodiment of the present invention;

FIG. 18 is a block diagram of a cache management unit which is included in the data control unit of the graphic processor according to the first embodiment of the present invention;

FIG. 19 is a conceptual view showing a relationship between status flags in the cache management unit and the cache memory, which are included in the data control unit of the graphic processor according to the first embodiment of the present invention;

FIG. 20 is a circuit diagram of the cache management unit which is included in the data control unit of the graphic processor according to the first embodiment of the present invention;

FIG. 21 is a state transition diagram of the data control unit of the graphic processor according to the first embodiment of the present invention;

FIG. 22 is a block diagram of the data control unit of the graphic processor according to the first embodiment of the present invention, FIG. 22 illustrating a scheme at a time of load;

FIG. 23 is a block diagram of the data control unit of the graphic processor according to the first embodiment of the present invention, FIG. 23 illustrating a scheme at a time of store;

FIG. 24 is a block diagram of the data control unit of the graphic processor according to the first embodiment of the present invention, FIG. 24 illustrating a scheme at a time of refill;

FIG. 25 is a state transition diagram of the data control unit of the graphic processor according to the first embodiment of the present invention;

FIG. 26 is a flow chart illustrating the operation of the graphic processor according to the first embodiment of the present invention at the time of load/store and refill;

FIG. 27 is a timing chart of various signals in the data control unit of the graphic processor according to the first embodiment of the present invention at the time of load/store and refill;

FIG. 28 is a circuit diagram of the cache management unit which is included in the data control unit of the graphic processor according to the first embodiment of the present invention;

FIG. 29 is a block diagram of the data control unit of the graphic processor, showing a structure for hit determination of a load/store instruction;

FIG. 30 is a block diagram of the data control unit of the graphic processor according to the first embodiment of the invention, showing a structure for hit determination of a load/store instruction;

FIG. 31 is a conceptual view of status flags in a cache management unit which is included in a data control unit of a graphic processor according to a second embodiment of the present invention;

FIG. 32 is a circuit diagram of the cache management unit which is included in the data control unit of the graphic processor according to the second embodiment of the present invention;

FIG. 33 is a block diagram of the data control unit of the graphic processor according to the second embodiment of the present invention, FIG. 33 illustrating a scheme at a time of write-back;

FIG. 34 is a flow chart illustrating an operation of the graphic processor according to the second embodiment of the invention at a time of write-back;

FIG. 35 is a block diagram of the graphic processor according to the second embodiment of the invention;

FIG. 36 is a conceptual view of an instruction table in a sub-pass information management unit which is included in a data control unit of a graphic processor according to a third embodiment of the present invention;

FIG. 37 is a flow chart illustrating the operation of the graphic processor according to the third embodiment of the invention at a time of preload;

FIG. 38 is a block diagram of the data control unit of the graphic processor according to the third embodiment of the present invention, FIG. 38 illustrating a scheme at a time of preload;

FIG. 39 is a timing chart illustrating states of sub-passes which are executed in the graphic processor according to the third embodiment of the present invention;

FIG. 40 is a conceptual view of status flags in a cache management unit which is included in a data control unit of a graphic processor according to a fourth embodiment of the present invention;

FIG. 41 is a flow chart illustrating a method of controlling entries according to lock flags in the cache management unit which is included in the data control unit of the graphic processor according to the fourth embodiment of the present invention;

FIG. 42 is a view showing states which can be taken by the data control unit of the graphic processor according to the fourth embodiment of the present invention;

FIG. 43 is a conceptual view of status flags in a cache management unit which is included in a data control unit of a graphic processor according to a fifth embodiment of the present invention;

FIG. 44 is a conceptual view showing a relationship between the status flags in the cache management unit and the cache memory, which are included in the data control unit of the graphic processor according to the fifth embodiment of the present invention;

FIG. 45 is a flow chart illustrating a method of controlling entries according to thread entry flags in the cache management unit which is included in the data control unit of the graphic processor according to the fifth embodiment of the present invention;

FIG. 46 is a block diagram of a partial region of a graphic processor according to a sixth embodiment of the present invention;

FIG. 47 shows a relationship between instructions, which are executed in the graphic processor according to the sixth embodiment of the invention, and stages;

FIG. 48 shows a relationship between instructions, which are executed in the graphic processor according to the sixth embodiment of the invention, and the stages, FIG. 48 illustrating a state at a time when stall has occurred;

FIG. 49 is a circuit diagram of a cache management unit which is included in the data control unit of the graphic processor according to the sixth embodiment of the present invention;

FIG. 50 shows a relationship between instructions, which are executed in the graphic processor, and the stages, FIG. 50 illustrating a state at a time when a stall has occurred;

FIG. 51 is a block diagram of a digital board which is included in a digital TV having the graphic processor according to the first to sixth embodiments of the invention; and

FIG. 52 is a block diagram of a recording/reproducing apparatus including the graphic processor according to the first to sixth embodiments of the invention.

### DETAILED DESCRIPTION OF THE INVENTION

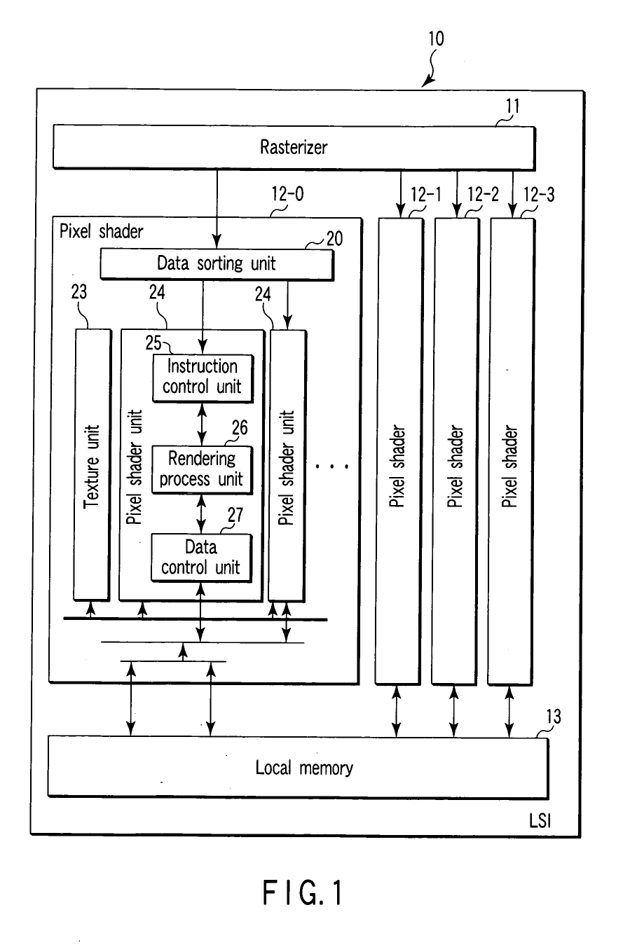

A graphic processor according to a first embodiment of the present invention will now be described with reference to FIG. 1. FIG. 1 is a block diagram of the graphic processor according to the first embodiment.

As shown in FIG. 1, a graphic processor 10 includes a rasterizer 11, a plurality of pixel shaders 12-0 to 12-3, and a local memory 13. In this embodiment, four pixel shaders 12 are provided, but the number of pixel shaders 12 is not limited to four. For example, the number of pixel shaders 12 may be 8, 16, 32, etc.

The rasterizer 11 generates pixels in accordance with input graphic information. The pixel is a minimum-unit region that is handled when a given graphic is to be rendered. A graphic is rendered by a set of pixels. The generated pixels are input to the pixel shaders 12-0 to 12-3.

The pixel shaders 12-0 to 12-3 execute arithmetic processes on the input pixels that are input from the rasterizer 11, and generate image data in the local memory 13. Each of the pixel shaders 12-0 to 12-3 includes a data sorting unit 20, a texture unit 23 and a plurality of pixel shader units 24.

The data sorting unit 20 receives data from the rasterizer 11. The data sorting unit 20 sorts the received data to the pixel shaders 12-0 to 12-3.

The texture unit 23 reads out texture data from the local memory 13 and executes a process that is necessary for texture mapping. The texture mapping is a process for attaching texture data to a pixel which is processed by the pixel shader unit 24. The texture mapping is executed in the pixel shader unit 24.

The pixel shader unit 24 is a shader engine unit and executes a shader program on pixel data. Each of the pixel shader units 24 executes an SIMD (Single Instruction Multiple Data) operation, and simultaneously processes a plurality of pixels. The pixel shader unit 24 includes an instruction control unit 25, a rendering process unit 26 and a data control unit 27. The details of these circuit blocks 25 to 27 will be described later.

The local memory 13 is, for example, an eDRAM (embedded DRAM) and stores pixel data which is rendered by the pixel shaders 12-0 to 12-3.

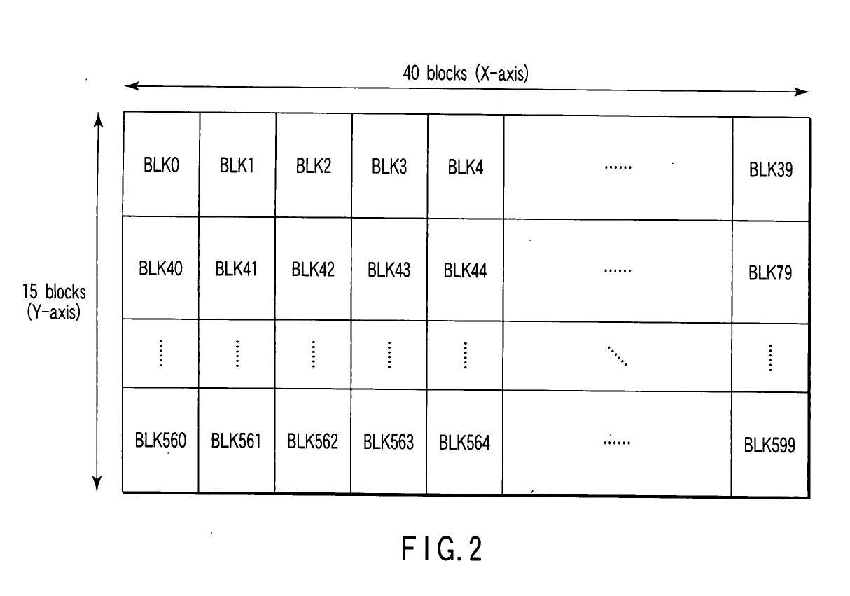

Next, the concept of graphic rendering in the graphic processor according to the present embodiment is explained. FIG. 2 is a conceptual view showing an entire space in which a graphic is to be rendered. The rendering space shown in FIG. 2 corresponds to a memory space (hereinafter referred to as “frame buffer”) which stores the pixel data within the local memory.

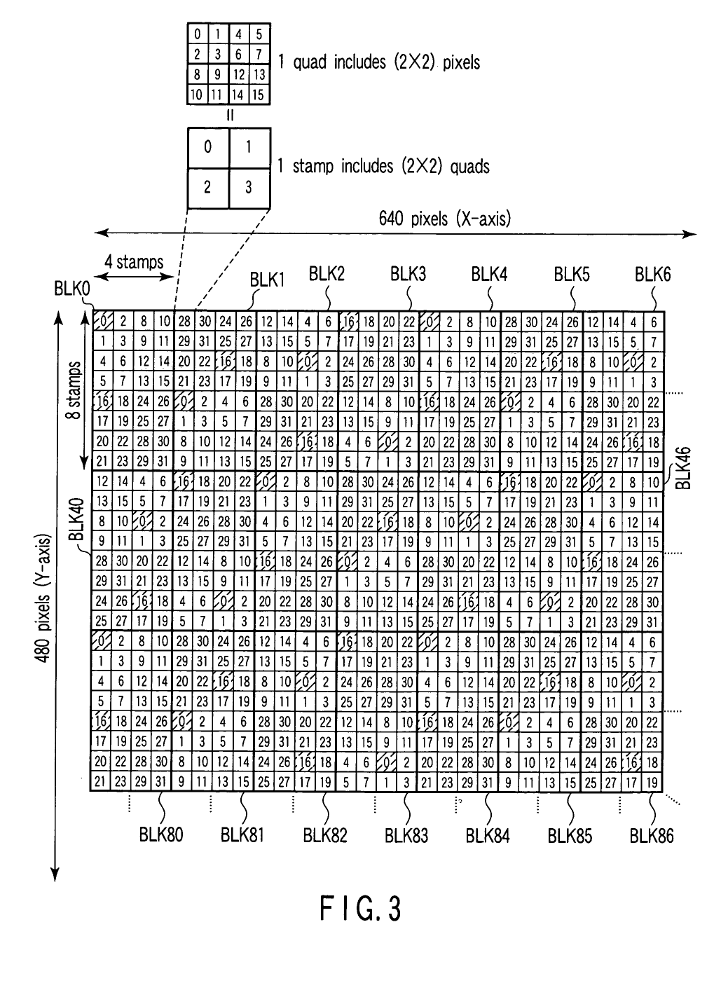

As is shown in FIG. 2, the frame buffer includes, for example, (40×15) blocks BLK0 to BLK599 which are arrayed in a matrix. Each block is a set of a plurality of pixels. This number of blocks is merely an example, and the number of blocks is not limited to (40×15). The pixel shaders 12-0 to 12-3 generate pixels in the order of blocks BLK0 to BLK599. Each of the blocks BLK0 to BLK599 includes sets of matrix-arrayed pixels. Each of the sets of pixels comprises, for example, (4×4)=16 pixels. In the description below, this set of pixels is referred to as “stamp”. Each of the blocks BLK0 to BLK599 comprises, e.g. 32 stamps. FIG. 3 shows the manner in which each of the blocks shown in FIG. 2 comprises a plurality of stamps.

Each of the stamps, as described above, is a set of pixels. The pixels that are included in the same stamp are rendered by the same pixel shader. The number of pixels, which are included in one stamp, is not limited to 16, and may be 1, 4, etc. In the case where the number of pixels included in one stamp is 1, the stamp may be referred to as “pixel”. In FIG. 3, the number (=0 to 31) which is added to each stamp is referred to as “stamp ID (StID)”, and the stamp ID identifies each stamp. The number (0 to 15) which is added to each pixel is referred to as “pixel ID (PixID)”, and the pixel ID identifies each pixel. A set of (2×2) pixels in each stamp is referred to as “quad”. Specifically, each stamp comprises (2×2) quads. The four quads are referred to as “quads Q0 to Q3”, and the number added to each quad is referred to as “quad ID”. The quad ID identifies each quad. Each of the blocks BLK0 to BLK599 comprises (4×8)=32 stamps. Accordingly, the space in which a graphic is to be rendered is composed of (640×480) pixels.

If the pixel shader units 24 are numbered in the order of the pixel shaders 12-0 to 12-3, the stamps having stamp IDs equal to the added numbers are processed by each pixel shader unit 24. In short, the pixel shader units, which process the pixels in each stamp, are predetermined in accordance with the positions of the pixels.

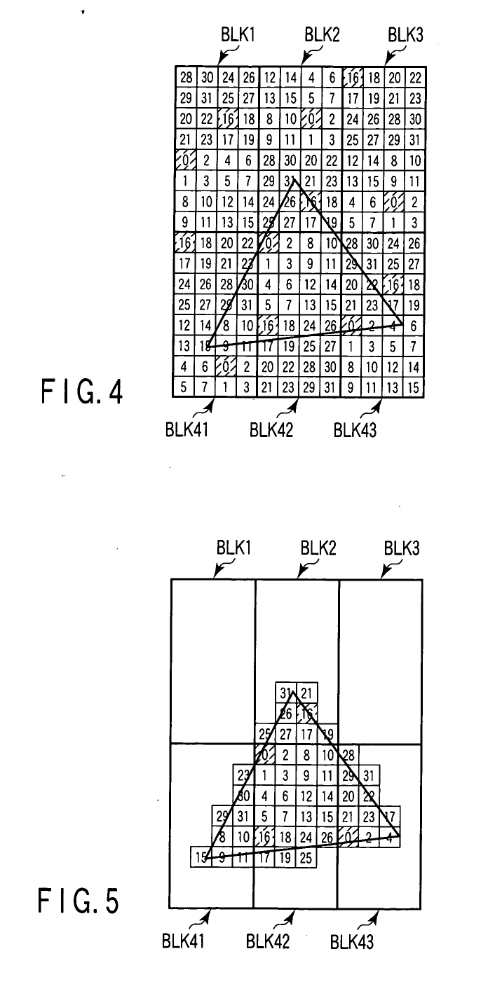

Next, a graphic to be rendered in the frame buffer is explained. In rendering a graphic, graphic information is input to the rasterizer 11. The graphic information is, for instance, apex coordinates and color information of the graphic. For example, the rendering of a triangle is explained. A triangle, which is input to the rasterizer 11, occupies positions, as shown in FIG. 4, in the rendering space. Assume now that the coordinates of the three apices of the triangle are located at a stamp of StID=31 in block BLK2, a stamp of StID=15 in block BLK41, and a stamp of StID=4 in block BLK43. The rasterizer 11 generates stamps corresponding to the positions occupied by the triangle to be rendered. FIG. 5 illustrates the process of stamp generation. The generated stamp data are sent to pre-associated pixel shaders 12-0 to 12-3.

On the basis of the input stamp data, the pixel shaders 12-0 to 12-3 execute rendering processes with respect to the pixels that are assigned to themselves. As a result, a triangle as shown in FIG. 5 is rendered by a plurality of pixels. The pixel data that are rendered by the pixel shaders 12-0 to 12-3 are stored in the local memory on a stamp-by-stamp basis.

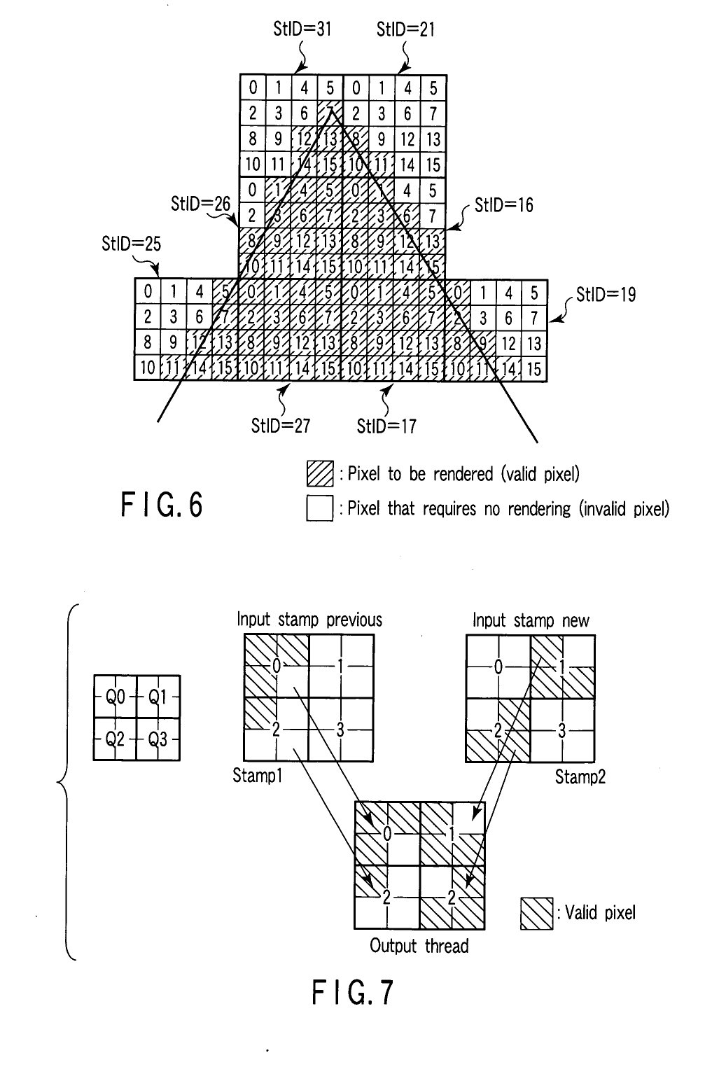

FIG. 6 is an enlarged view of the block BLK2 in FIG. 5. As shown in FIG. 6, the rasterizer 11 generates eight stamps with respect to the block BLK2. The stamp IDs of the generated stamps are StID=16, 17, 19, 21, 25-27 and 31. As described above, each of the stamps generated by the rasterizer 11 includes (4×4)=16 pixels. However, even if stamps are generated, there is no need to execute a rendering process for all the pixels, depending on graphics. For example, in FIG. 6, the stamps with StID=17 and 27 are present within the triangle, and it is necessary to execute a rendering process for all the pixels included in these stamps. However, in the stamp of StID=21, for instance, pixels with PixID=0-7, 9, 12-15 are present outside the triangle, so a rendering process therefor is needless. The pixels that require the rendering process are only pixels with PixID=8, 10 and 11. In the description below, the pixels that are to be subjected to a rendering process are referred to as “valid” pixels, and the pixels that require no rendering process are referred to as “invalid” pixels”.

Referring back to FIG. 1, the structure of the pixel shader unit 24 is described. As is shown in FIG. 1, the pixel shader unit 24 includes an instruction control unit 25, a drawing process unit 26 and a data control unit 27. The instruction control unit 25 executes task execution management, stamp data reception, quad merge, sub-pass execution management, etc. The rendering process unit 26 executes an arithmetic process for pixels. The data control unit 27 includes a cache memory, and controls data access to the cache memory and the local memory 13.

The operation of the instruction control unit 25 is described. The instruction control unit 25 executes a pipeline operation. The instruction control unit 25 receives a plurality of data from the data sorting unit 20 and stores the data. The data are, for instance, XY coordinates of stamps, directions of rendering, face information of polygons, representative values of parameters which are possessed by a graphic to be rendered, depth information of a graphic, or information indicative of whether pixels are valid or not. The instruction control unit 25 also executes a process of merging two stamps into one stamp. In the description below, this process is referred to as “quad merge”. Two stamps that are to be merged by a quad merge are stamps which are present at the same XY coordinates and are temporally successive. By the quad merge, valid quads in two stamps can be compounded into one stamp and can be processed at a time. Thus, the amount of data to be subjected to the rendering process can be compressed. FIG. 7 illustrates the quad merge.

Assume now that two temporally successive stamps are as shown in FIG. 7. The four quads included in one stamp are referred to as quads Q0 to Q3. To begin with, the following case is considered. A stamp 1, in which quads Q0 and Q2 are valid and quads Q1 and Q3 are invalid, is input to the instruction control unit 25. Subsequently, a stamp 2, in which quads Q1 and Q2 are valid and quads Q0 and Q3 are invalid, is input to the instruction control unit 25. In this case, the two stamps 1 and 2 are merged to generate a new stamp including quads Q0 and Q2 of stamp 1 and quads Q1 and Q2 of stamp 2. The new stamp is referred to as “thread” in order to distinguish the new stamp from the stamps before the quad merge. The thread that is generated by the quad merge is numbered, and the number added to the thread is referred to as “thread ID (TdID)”. The instruction control unit 25 stores information relating to the generated thread. The information relating to the thread is, for instance, a thread ID, and information relating to the positions of the four quads, which are included in the thread, in the pre-quad-merge stamps. Further, the information relating to the thread includes information relating to an instruction that is currently being executed. A description of this information will be given below.

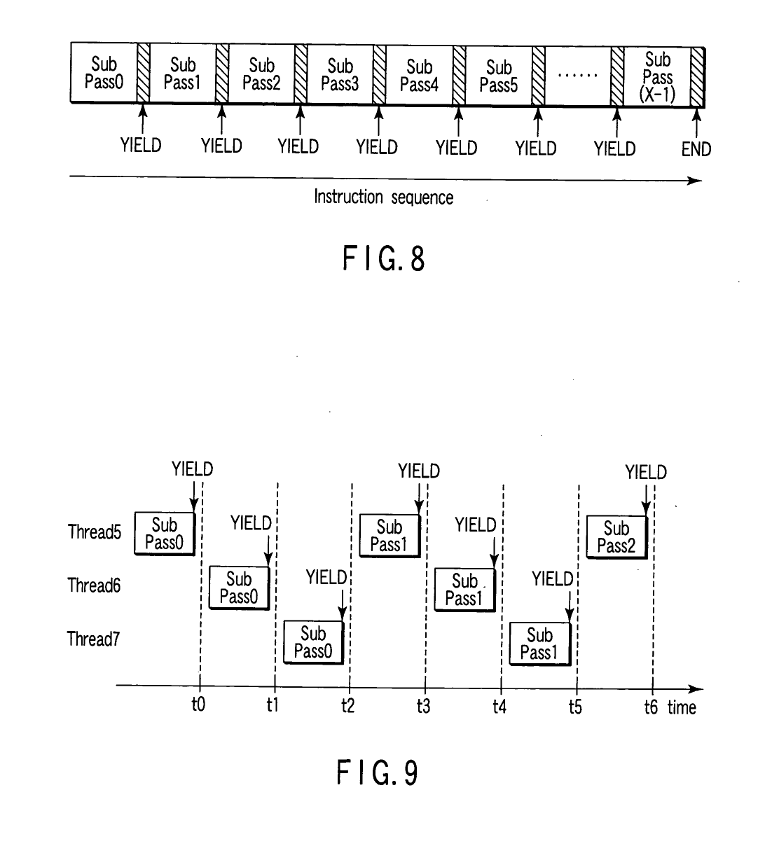

FIG. 8 is a schematic diagram of a sequence of one instruction that is executed by the instruction control unit 25, and the instruction sequence is illustrated along a time axis. As shown in FIG. 8, the instruction sequence can be divided into an X-number of instruction sequences at maximum. In the description below, each of a plurality of instruction sequences, which are obtained by dividing one instruction sequence, is referred to as “sub-pass”. A yield instruction YIELD is disposed at the end of each sub-pass, and an end instruction END is disposed, in place of the yield instruction, at the end of the last sub-pass. The instruction control unit 25 executes the instruction sequence, as shown in FIG. 8, for each thread until the end signal is detected. In the description below, the sub-passes that are included in one instruction sequence are referred to as sub-pass 0 to sub-pass (X-1) in the order of execution, and numerals 0 to (X-1), which are assigned in the order of execution, are referred to as “sub-pass IDs”. Thus, the above-mentioned information relating to the instruction that is being executed is the sub-pass ID of the currently executed sub-pass, and the information may include the sub-pass ID of a sub-pass that is to be next executed.

FIG. 9 is a conceptual view showing the scheme of execution of sub-passes with the passing of time. In FIG. 9, threads 5, 6 and 7 are processed by the same pixel shader unit. As shown in FIG. 9, the process for a thread is temporarily halted by the yield instruction. Then, the instruction for another thread is executed. The halted thread is restarted when it is rendered issuable later. In short, the sub-pass is an instruction that is executed between two yield instructions. The thread is executed in units of a sub-pass, and the process in the period of the sub-pass is continuously executed.

The instruction control unit 25 executes a control of the sub-passes. The instruction control unit 25 holds threads and sub-pass IDs corresponding to the thread, and manages which of the threads is issuable.

Further, the instruction control unit 25 interpolates pixel data on the basis of the information that is supplied from the data sorting unit 20. In usual cases, the number of pixels that are generated by the rasterizer is only one per stamp. Thus, by the calculation based on the pixel data generated by the rasterizer 11, the rendering process unit 26 obtains information relating to other pixels in the same stamp.

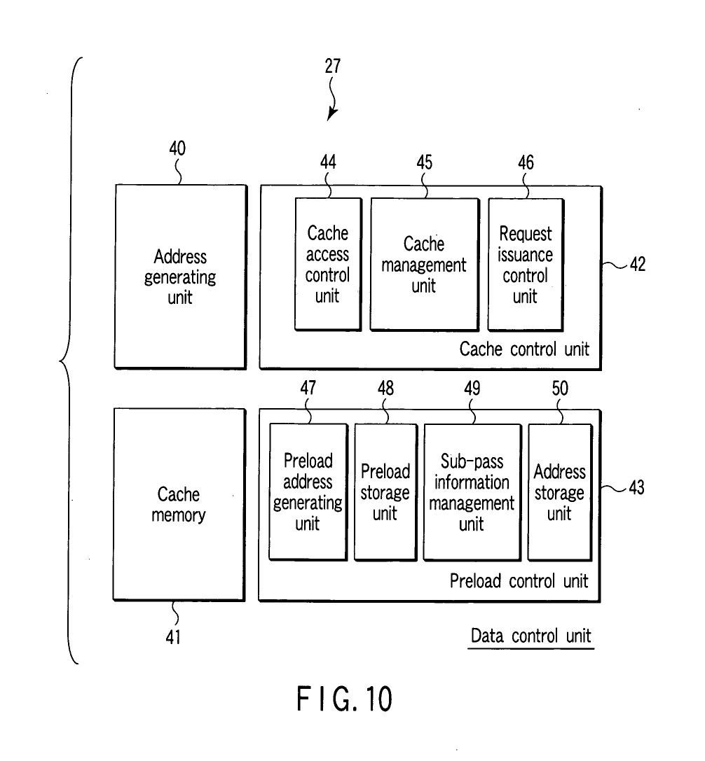

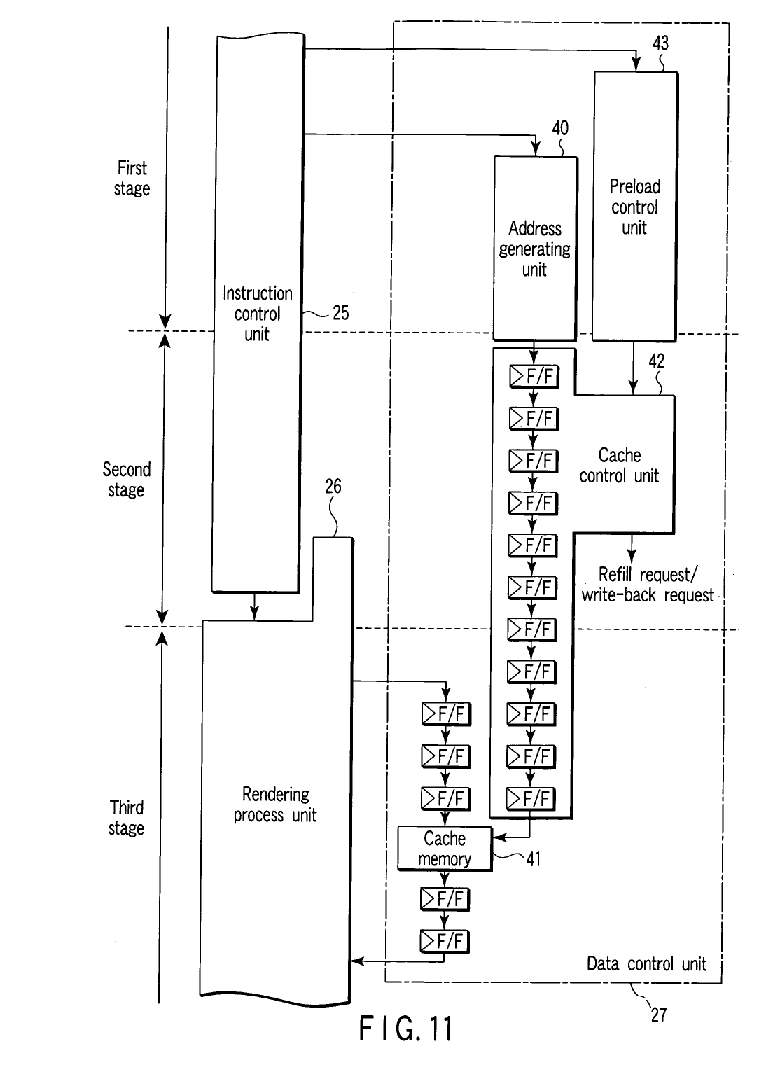

Next, the data control unit 27 is described with reference to FIG. 10 and FIG. 11. FIG. 10 is a block diagram of the data control unit 27. The data control unit 27 executes a pipeline operation. FIG. 11 is a block diagram of the data control unit 27 which is depicted in association with respective stages of the pipeline operation.

A process in each circuit block of the pixel shader unit includes at least three stages, i.e. first to third stages. The respective stages will now be generally described. In the first stage, the instruction control unit 25 executes read-out of necessary data, prefetch of instructions, etc. In addition, the data control unit 27 executes generation of address signals necessary for data access, and a control relating to preload (to be described later). In the second stage, the instruction control unit 25 executes interpolation of pixel data, and the data control unit 27 generates instructions necessary for data access. In the third stage, on the basis of the process result in the instruction control unit 25 and data control unit 27, the rendering process unit 26 performs the rendering process. The reception of data from the data sorting unit 20 by the instruction control unit 25 is executed at a stage prior to the first stage.

The structure of the data control unit 27 is described. As shown in the Figures, the data control unit 27 includes an address generating unit 40, a cache memory 41, a cache control unit 42 and a preload control unit 43. The address generating unit 40 generates, when a load/store instruction is issued from the instruction control unit 25, an address of data to be read out of the local memory 13 or an address of data to be written in the local memory 13 (hereinafter referred to as “load/store address”). The load/store instruction is an instruction (load instruction) for reading out data that is necessary when the rendering process unit 26 executes a pixel process, or an instruction (store instruction) for storing the processed data. To be more specific, if the load instruction is issued, the data that is necessary for the pixel rendering process is read out of the cache memory 41 into a register which is provided in the rendering process unit 26. If the necessary data is not present in the cache memory 41, it is read out of the local memory 13. If the store instruction is issued, the data stored in the register in the rendering process unit 26 is temporarily written in the cache memory 41 and then written in the local memory 13.

The cache memory 41 temporarily stores pixel data. The rendering process unit 26 executes a pixel process using the data stored in the cache memory 41.

The cache control unit 42 controls access to the cache memory 41 at a time when the load/store instruction is issued. The cache control unit 42 includes a cache access control unit 44, a cache management unit 45 and a request issuance control unit 46.

The preload control unit 43 controls access to the cache memory 41 at a time when the preload instruction is issued. The preload control unit 43 includes a preload address generating unit 47, a preload storage unit 48, a sub-pass information management unit 49 and an address storage unit 50. The preload instruction is an instruction for prefetching data, which is used in a sub-pass of a thread that is to be next executed, from the local memory into the cache memory 41.

The data control unit 27 includes a configuration register in any one of the above-described circuit blocks. The configuration register stores a signal WIDTH, BASE and PRELOAD. The signal WIDTH is indicative of the size of the frame buffer relating to pixels. BASE is indicative of a base address (first address) of the data stored in the local memory 13 with respect to each of a frame buffer mode and a memory register mode. PRELOAD is a signal for setting ON/OFF of preload.

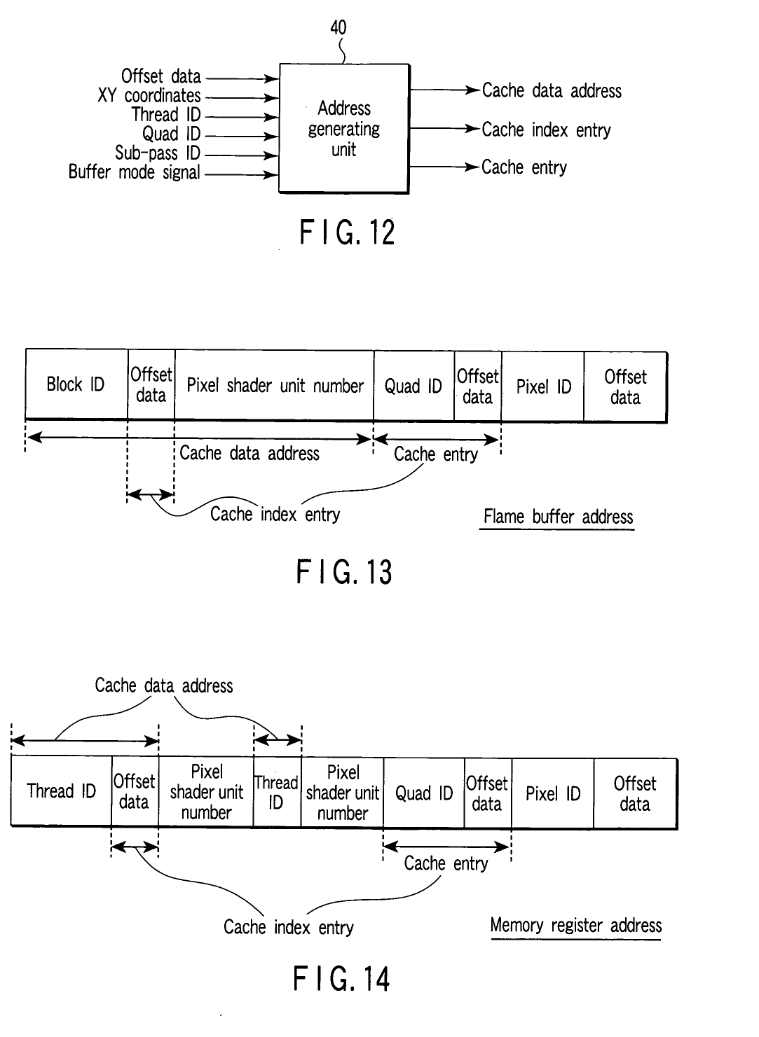

The internal structure of the data control unit 27 is described in detail. The address generating unit 40 is first described. FIG. 12 is a block diagram of the address generating unit 40, and shows input/output signals. As shown in FIG. 12, offset data, XY coordinates of the thread, thread ID, quad ID, sub-pass ID and a buffer mode signal are input to the address generating unit 40. The XY coordinates are given from the instruction control unit 25. The thread ID, quad ID and sub-pass ID are given from the rendering process unit 26. The address generating unit 40 calculates a load/store address on the basis of the X coordinate and Y coordinate of the thread, and the WIDTH that is stored in the configuration register. It should suffice if the load/store address is calculable from the above-described information, and the calculation formula itself is not limited. Shown below is an example of the calculation method of the load/store address in a case where the number of pixel shader units is four and one block comprises 32 stamps.
Block ID=(X/16)+(Y/32)×(WIDTH/16)
Xr=(X/4) mod 16
Yr=(Y/4) mod 16
PUID[0]=Xr[1]ˆYr[1]=StID[0]
PUID[1]=(Xr[1] AND ˜(Yr[1]ˆYr[2])|(˜Xr[1] AND Xr[2]))ˆXr[0]ˆYr[0]
=StID[1]
PUID[2]=(Xr[1] AND ˜(Yr[1]ˆXr[2])|(˜Xr[1] AND Yr[2]))ˆXr[0]ˆYr[0]
=StID[2]
PUID[3]=Xr[3]=StID[3]
PUID[4]=Yr[3]=StID[4]

The block ID in the above formula is the number of each of BLK0 to BLK599 as described with reference to FIG. 2. X and Y are an X coordinate and a Y coordinate. PUID is the pixel shader number, which is added to the associated pixel shader unit 24 when the pixel shader units 24 are numbered in the order of pixel shaders 12-0 to 12-3. The pixel shader unit number is a 5-bit signal, and PUID[0] to PUID[4] indicate the bits of the signal. The Xr and Yr are 4-bit signal, and Xr[0] to Xr [3] and Yr[0] to Yr[3] indicates the bits of the signal. As regards the operators in the above formula, mod indicates a residue, AND indicates an AND operation, ˆ indicates an exclusive OR operation, ˜ indicates a NOT operation, and | indicates an OR operation.

The address generating unit 40 arranges the result of the above calculation, offset data, quad ID and pixel ID in an order as shown in FIG. 13 or FIG. 14, thereby generating a 32-bit load/store address. The local memory 13 can store data in two modes. The two modes are referred to as “frame buffer mode” and “memory register mode”, respectively. The load/store address is found from the XY coordinates in the case where the local memory is used in the frame buffer mode, and is obtained with the arrangement shown in FIG. 13. On the other hand, the load/store address is found from the thread ID in the case where the local memory is used in the memory register mode, and is obtained with the arrangement shown in FIG. 14. The offset data is given from the instruction control unit 25. Which of the frame buffer mode and memory register mode is to be used is represented by the buffer mode signal from the instruction control unit 25. The pixel ID is understandable from XY coordinates. The reason is that the position of the pixel with pixel ID within the stamp is predetermined, as has been described with reference to FIG. 3. For the same reason, the quad ID can be understood.

If the address generating unit 40 generates the address shown in FIG. 13 or FIG. 14, it outputs parts of the address as “cache data address”, “cache index entry” and “cache entry”. These signals are signals indicative of addresses within the cache memory 41, as will be described later in detail.

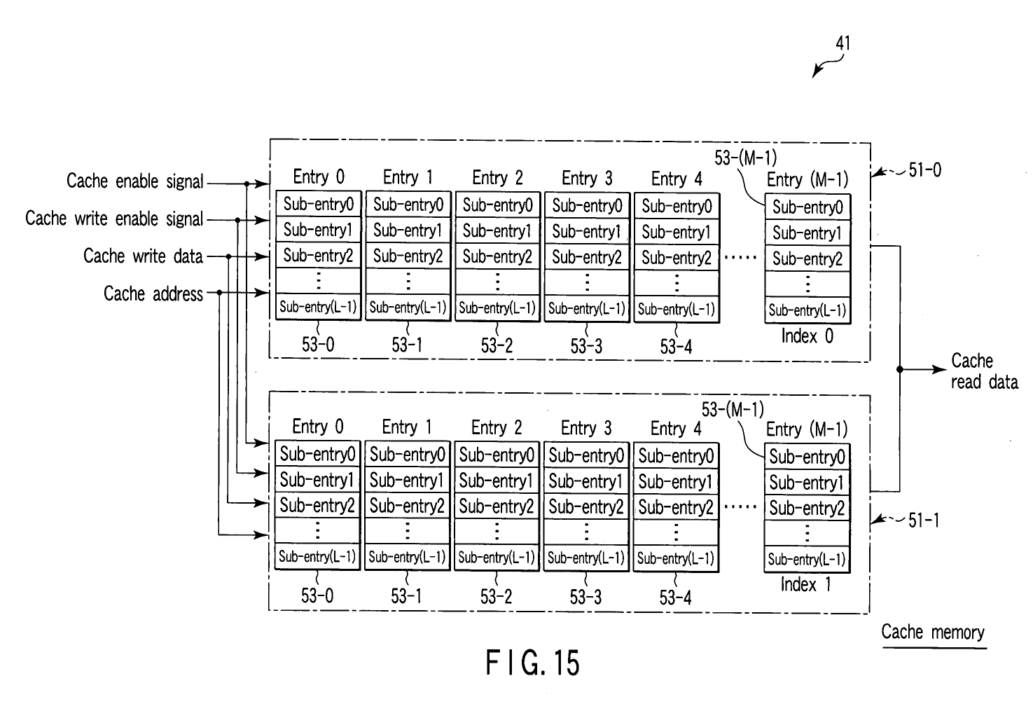

Next, the cache memory 41 is described with reference to FIG. 15. FIG. 15 is a block diagram of the cache memory 41. As shown in FIG. 15, the cache memory 41 includes, for example, two memories 51-0 and 51-1. The memory 51-0, 51-1 is, for instance, an SRAM or a DRAM. Each of the memories 51-0 and 51-1 includes an M-number of entries 0 to (M−1). The entries 0 to (M−1) are independent memories 53-0 to 53-(M−1). Further, each of the entries 0 to (M−1) includes an L-number (L=a natural number of 2 or more) of sub-entries 0 to (L−1). When data is read out of the cache memory 41, data is read out as cache read data from any one of the sub-entries of any one of the entries in the memory 51-0, and from any one of the sub-entries of any one of the entries in the memory 51-1.

In FIG. 15, each of the entries 0 to (M−1) includes the L sub-entries 0 to (L−1) for the reason that the transferable data size of the bus that connects the cache memory 41 and the outside is (1/L) of each entry size in the memory 51-0, 51-1. Thus, if the transferable data size of the bus is equal to or greater than the entry size, it is not necessary that the entry have sub-entries. In this case, the data with the entry size is read out to the outside.

In FIG. 15, the cache memory 41 includes two memories 51-0 and 51-1. The number of these memories is merely an example, and may be one, or three or more. An index 0 and an index 1 are assigned as identification numbers to the two memories 51-0 and 51-1 that are included in the cache memory 41. Of the address signals described with reference to FIG. 12 to FIG. 14, the cache index entry and cache data address include information as to which of the index 0 and index 1, which are assigned to the memories 51-0 and 51-1, is to be selected. In addition, the cache entry includes information as to which of the sub-entries 0 to (L−1) is to be selected. The cache memory 41 receives from the cache access control unit 44 a cache enable signal, a cache write enable signal, a cache write data and a cache address. The cache enable signal is a signal for setting the cache memory 41 in an enable state. The cache write enable signal is a signal for enabling a write operation for writing in the cache memory 41. The cache write data is write data that is to be written in the cache memory 41. The cache address is indicative of an address to be accessed in the cache memory.

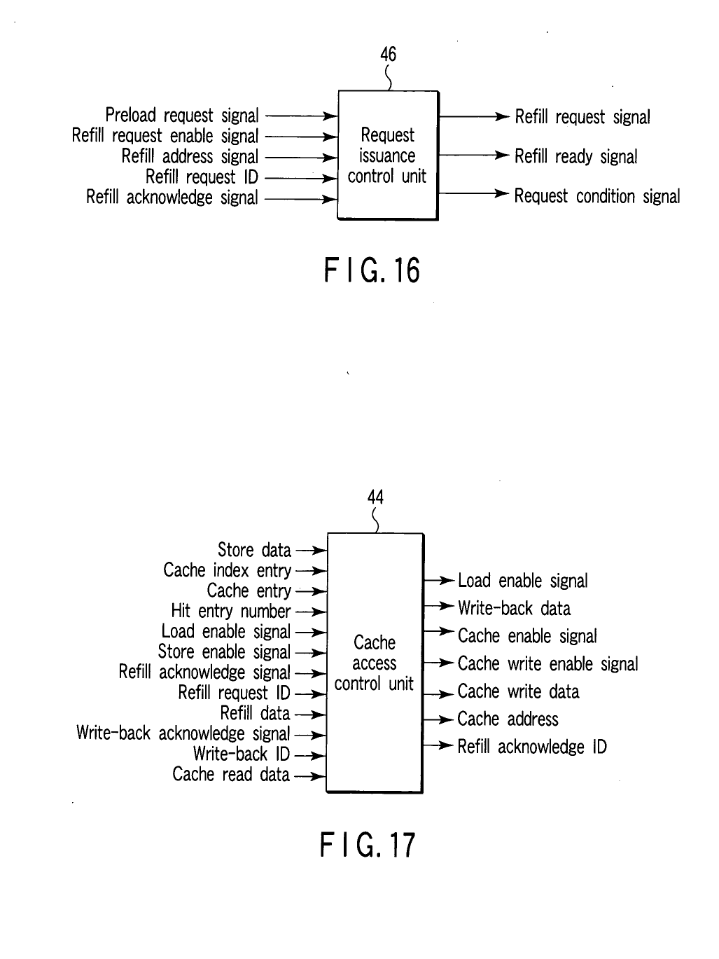

Next, the cache access control unit 44, cache management unit 45 and request issuance control unit 46, which are included in the cache control unit 42, are described. To begin with, the request issuance control unit 46 is described with reference to FIG. 16. FIG. 16 is a block diagram of the request issuance control unit 46, and shows input/output signals. As shown in FIG. 16, the request issuance control unit 46 receives a preload request enable signal, a refill request enable signal, a refill address, a refill request ID and a refill acknowledge signal. The preload request enable signal is delivered from the cache management unit 45, and it is asserted if a preload request is output. The refill request enable signal, refill address and refill request ID are delivered from the cache management unit 45, and indicate an enable signal, an address and a request ID of a refill request, respectively. When a load/store instruction is issued, if there is no associated data in the cache memory 41, it is necessary to read out the associated data from the local memory into the cache memory 41. This operation is referred to as “refill”. The refill acknowledge signal is delivered from the local memory 13, and is an acknowledge signal relating to the refill request.

The request issuance control unit 46 controls the issuance of the refill request and preload request. Specifically, the total number of refill requests and preload requests to the local memory 13 is counted. If the refill acknowledge signal is returned from the local memory 13, the number of these requests is counted down. The reason is that there is an upper limit to the number of requests, which can be accepted by the local memory 13. The priority of the refill is higher than the priority of the preload. Thus, in the case where the refill request and preload request stand by for issuance at the same time, the refill request is preferentially issued. At a proper timing, a refill request signal is output to the local memory 13. In addition, the request issuance control unit 46 outputs to the address storage unit 50 a refill ready signal which indicates the presence/absence of a refill request standing by for issuance to the local memory 13. Further, the request issuance control unit 46 outputs to the address storage unit 50 a request condition signal which indicates the presence/absence of a request queue in the local memory 13, that is, indicates whether the refill request and preload request can be issued to the local memory 13.

Next, the cache access control unit 44 is described with reference to FIG. 17. FIG. 17 is a block diagram of the cache access control unit 44, and shows input/output signals. As shown in FIG. 17, the cache access control unit 44 receives store data, the cache index entry, the cache entry, a hit entry number, a load enable signal, a store enable signal, the refill acknowledge signal, the refill request ID, refill data, a write-back acknowledge signal, a write-back ID, and cache read data.

The store data is data to be stored in the cache memory 41, and is delivered from the rendering process unit 26. The hit entry number is given from the cache management unit 45. When the load/store instruction is issued, the hit entry number indicates whether the associated data is present in the cache memory 41, and indicates, if the associated data is present, which of the entries of the cache memory 41 stores the associated data. The hit entry number will be described later in greater detail. The load enable signal and store enable signal are delivered from the cache management unit 45 and the rendering process unit 26 of the shader program execution unit, respectively, and these signals are asserted when the load request and store request are issued. The refill acknowledge signal, refill request ID and refill data are delivered from the local memory 13. The write-back acknowledge signal and write-back ID are signals relating to the write-back operation, indicate an acknowledge signal and an ID, respectively, and are delivered from the local memory 13. The write-back refers to an operation of writing data, which is stored in the cache memory 41, into the local memory, as will be described later in greater detail in connection with a second embodiment of the invention.

In addition, the cache access control unit 44 outputs the load enable signal, write-back data, the cache enable signal, the cache write data, the cache address and the refill acknowledge ID. The load enable signal is delivered to the rendering process unit 26. The write-back data is data that is to be written in the local memory 13 at the time of write-back, and is delivered to the local memory 13. The refill acknowledge ID is a signal indicative of an acknowledge ID of refill, and is delivered to the cache management unit 45.

The cache access control unit 44 controls data write to the cache memory 41 and data read from the cache memory 41. Accesses to the cache memory 41 are four kinds: load, store, refill and write-back. When the cache memory 41 is to be accessed, the cache access control unit 44 asserts the cache enable signal.

In the case where refill is to be executed, after passage of a predetermined time from the arrival of the refill acknowledge signal to the cache access control unit 44, the refill data reaches the cache access control unit 44 from the local memory 13. After the cache access control unit 44 temporarily holds the refill data, it writes the refill data into the cache memory 41. When the refill data is to be written in the cache memory 41, the cache access control unit 44 asserts the cache write enable signal and outputs the cache write data and cache address to the cache memory 41. Further, upon receiving the refill acknowledge signal from the local memory 13, the cache access control unit 44 outputs the refill acknowledge ID to the cache management unit 45.

In the case where write-back is to be executed, the cache access control unit 44 temporarily holds the cache read data that is read out of the cache memory 41, and then outputs the cache data as write-back data to the local memory 13.

In the case where store is to be executed, the store enable signal is asserted and the store data is delivered from the rendering process unit 26. The cache access control unit 44 writes the store data in the cache memory 41.

In the case where load is to be executed, the load enable signal is asserted. The cache access control unit 44 reads out the cache read data from the cache memory 41. This data is also delivered to the rendering process unit 26 at the same time.

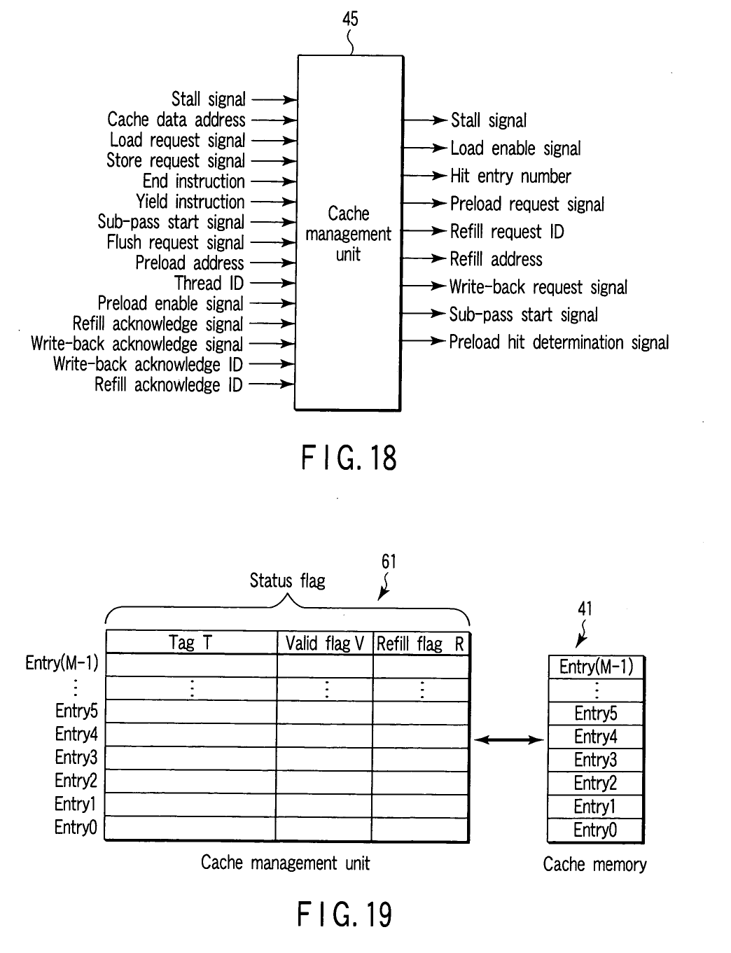

Next, the cache management unit 45 is described with reference to FIG. 18. FIG. 18 is a block diagram of the cache management unit 45, and shows input/output signals. As shown in FIG. 18, the cache management unit 45 receives a stall signal, the cache data address, a load request signal, a store request signal, the end instruction, the yield instruction, a sub-pass start signal, a thread entry number, a flush request signal, the preload address, a preload thread ID, a preload enable signal, the refill acknowledge signal, the write-back acknowledge signal, a write-back acknowledge ID, and the refill acknowledge ID.

The stall signal is delivered from the rendering process unit 26. “Stall” refers to a state in which an instruction is not executable due to some cause and the execution of the instruction is being awaited. The load request signal and the store request signal are delivered from the rendering process unit 26. The end instruction and the yield instruction are delivered from the rendering process unit 26. The sub-pass start signal is a signal indicative of the start of the sub-pass, and is delivered from the rendering process unit 26. The flush request signal is a signal for requesting flush (erasing the data) of the cache memory 41, and is delivered from the rendering process unit 26.

The preload address, preload thread ID and preload enable signal are signals relating to preload, and are delivered from the address storage unit 50 of the preload control unit 43.

In addition, the refill acknowledge signal and refill acknowledge ID are delivered to the cache management unit 45 from the local memory 13 and cache access control unit 44, respectively. Further, the write-back acknowledge signal and write-back acknowledge ID are delivered from the local memory 13 and cache access control unit 44, respectively.

The cache management unit 45 executes hit determination of the cache memory 41, the status management of entries, the determination of a request issuance entry, the management of LRF, and the flush control of the cache memory 41.

The hit determination of the cache memory 41 is explained. For example, in the case where a load instruction is issued, it is necessary to load necessary data from the cache memory 41 into the rendering process unit 26. At this time, there arises no problem if necessary data is stored in the cache memory 41. However, if necessary data is not stored in the cache memory 41, it is necessary to read out the data from the local memory into the cache memory 41 (“refill”). This operation of determining whether the necessary data is stored in the cache memory 41 is referred to as “hit determination”. The hit determination result is output to the cache access control unit 44 as the hit entry number.

If a cache miss of the load/store instruction or preload instruction occurs (i.e. if these instructions are not stored in the cache memory 41), the cache management unit 45 outputs the refill request enable signal and refill address to the request issuance control unit 46.

In addition, the cache management unit 45 executes status management of the entries of the cache memory 41. For this purpose, the cache management unit 45 includes a memory 61 which is provided in association with the entries of the cache memory 41 and stores status flags. The status flag indicates the status of the associated entry in the cache memory 41. FIG. 19 is a conceptual view of the memory 61. The memory 61 is, for instance, an SRAM or a flip-flop, and is provided in association with the memory 51-0, 51-1. FIG. 19 shows only the status flags associated with one of the memories 51-0 and 51-1.

As is shown in FIG. 19, like the memory 51-0, 51-1, the memory 61 includes an M-number of entries 0 to (M−1). Each entry stores, as status flags, a tag T, a valid flag V, and a refill flag R. The tag T relates to an address signal of data that is stored in the associated entry. To be more specific, the tag T is associated with parts of the block IDs and pixel shader unit numbers which are included in the address signal that has been described with reference to FIG. 13. In addition, the tag T is associated with the thread ID which is included in the address signal that has been described with reference to FIG. 14.

The valid flag V is a flag which indicates whether the data stored in the associated entry is valid or not. The entry becomes valid if a refill request is issued, and becomes invalid if flush is executed.

The refill flag R is a flag which indicates that the refill request is being issued. The refill flag R continues to be asserted from the issuance of the refill request until the actual completion of the data transfer (referred to as “replace”) from the local memory 13 to the cache memory 41.

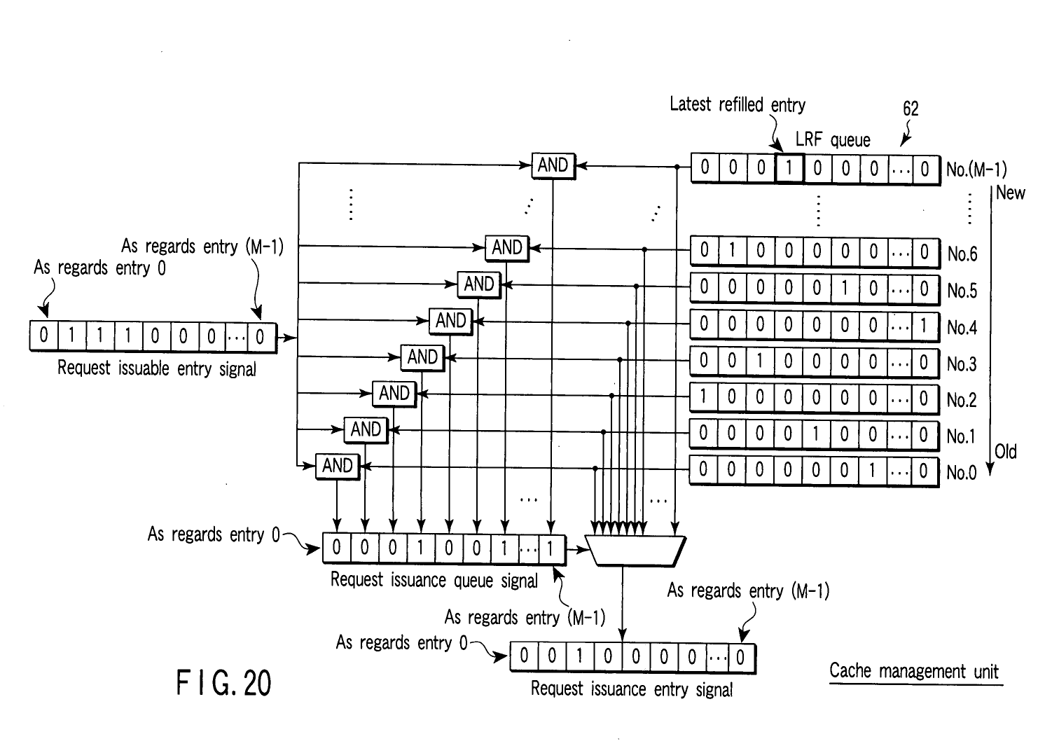

The determination of the request issuance entry is to determine the entry in the cache memory 41, in which the data is to be stored at the time of refill or preload. The entries are used in the order beginning with one which was refilled earliest. This point is explained with reference to FIG. 20.

FIG. 20 is a diagram of the cache management unit 45. In order to determine the issuance entry, the cache management unit 45 includes a memory 62 which includes an M-number of M-bit entries. The memory 62 stores an LRF queue (Least Recently Filled queue). The LRF queue indicates the order in which refill is executed in the cache memory 41. The bits of the entries 0 to (M−1) of the memory 62 are successively associated with the entries 0 to (M−1) of the cache memory 41 in the order from the most significant bit, and the execution of refill is older in the order of the entries 0 to (M−1) of the memory 62. Thus, in the case of the example of FIG. 20, the most recently refilled entry of the cache memory 41 is the entry 3, as shown by the entry (M−1) of the memory 62, which is followed by entry 1, entry 5, . . . .

Based on the status flag shown in FIG. 19, the cache management unit 45 generates a request issuable entry signal. The request issuable entry signal is a signal indicating which of the entries is a currently request issuable entry. The request issuable entry signal corresponds to the entries 0 to (M−1) of the cache memory 41 in the order from the most significant bit. Thus, in the example of FIG. 20, it is understood that the entries 1, 2 and 3 of the cache memory 41 are capable of issuing requests.

The cache management unit 45 executes AND operations of the LRF queues and the request issuable entry signals. By arranging in order the AND operation results of the (M−1) LRF queues and request issuable entry signals, the request issuance queue signal is obtained. The request issuance queue signal indicates which of the entries of the LRF queue should be a basis for determining the issuance entry, and the request issuance queue signal is associated with the entries 0 to (M−1) of the memory 62 in the order from the most significant bit. In the example of FIG. 20, it is understood that the issuance entries should be determined on the basis of the LRF queues stored in the entries 3, 6 and (M−1) of the memory 62. The issuable entries in the cache memory 41 are entries 1, 2 and 3, and it is understood from the LRF queue that the earliest refilled entry of the cache memory 41 is the entry 2. Thus, in the cache memory 41, the request issuance entry is determined to be the entry 2. This is indicated by the request issuance entry signal. This signal, too, is associated with the entries 0 to (M−1) of the cache memory 41 in the order from the most significant bit, and the entry corresponding to the bit “1” is the request issuance entry. The circuit shown in FIG. 20 is provided in association with each of the memories 51-0 and 51-1 included in the cache memory 41.

Next, the preload control unit 43 in FIG. 10 is described. The preload address generating unit 47 generates address signals at the time of preload. The preload storage unit 48 executes management of the thread for which the preload request is issued. The sub-pass information management unit 49 stores information relating to the buffer which has been accessed in the sub-pass. The address storage unit 50 stores the address signal that has been generated in the preload address generating unit 47. In the above-described structure, the generated preload address is delivered to the cache management unit 45. As regards the preload, a detailed description will be given in a third embodiment of the invention.

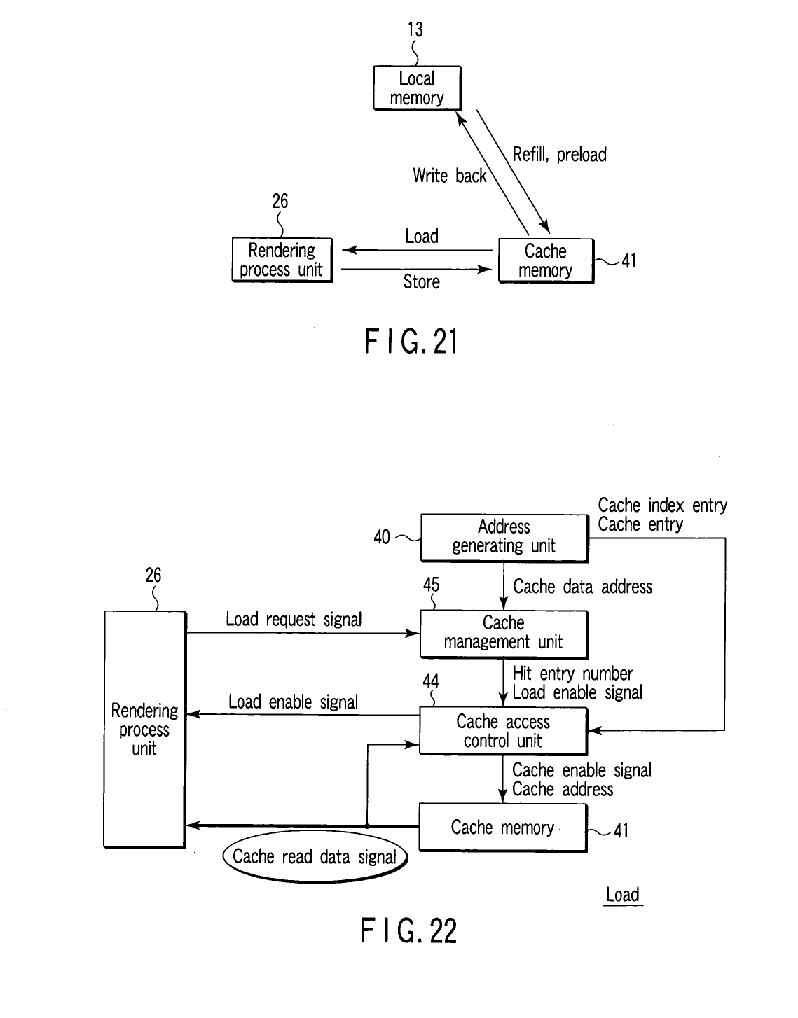

Next, the operation of the data control unit 27 is described. The data control unit 27 manages the data transmission/reception between the cache memory 41, local memory 13 and rendering process unit 26. As is illustrated in FIG. 21, there are four kinds of data transmission/reception, i.e. preload, load/store, refill, and write-back. FIG. 21 is a conceptual view illustrating transmission/reception of data and signals at the time of executing preload, load/store, refill and write-back. In the present embodiment, a description is given of the load/store and refill.

The load operation at a time when the load/store instruction is issued is described with reference to FIG. 22. FIG. 22 is a block diagram of the pixel shader unit. “Load” is an operation for transferring data from the cache memory 41 to the rendering process unit 26.

To begin with, the load request signal is delivered from the rendering process unit 26 to the cache management unit 45. The address generating unit 40 generates addresses by the method as described with reference to FIG. 13 and FIG. 14, delivers the cache data address signal to the cache management unit 45, and delivers the cache index entry signal and cache entry signal to the cache access control unit 44. Then, the cache management unit 45 executes the hit determination, delivers the hit entry number to the cache access control unit 44, and delivers the load enable signal to the cache access control unit 44.

The cache access control unit 44 generates the cache enable signal and enables the cache memory 41. Further, the cache access control unit 44 accesses the address in the cache memory 41, which corresponds to the cache index entry signal and cache entry signal, and reads out data from the cache memory 41. The cache access control unit 44 returns the load enable signal to the rendering process unit 26. The cache read data, which has been read out of the cache memory 41, is transferred to the rendering process unit 26.

In the above-described manner, the data (cache read data) in the cache memory 41 is loaded in the rendering process unit 26.

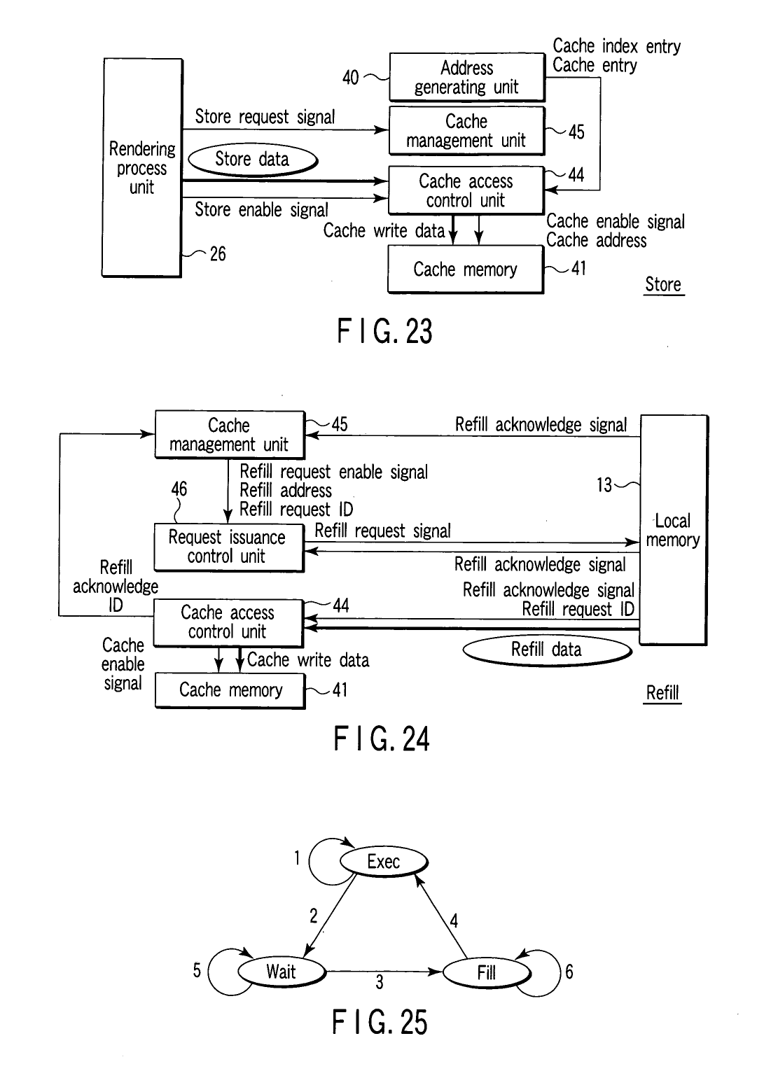

Next, the store operation is described with reference to FIG. 23. FIG. 23 is a block diagram of the pixel shader unit. “Store” is an operation for storing data, which has been processed in the rendering process unit 26, into the cache memory 41.

To start with, the store request signal is delivered from the rendering process unit 26 to the cache management unit 45. In addition, the address generating unit 40 generates addresses and delivers the cache index entry signal and cache entry signal to the cache access control unit 44. Further, the store enable signal and store data are delivered from the rendering process unit 26 to the cache access control unit 44.

The cache access control unit 44 generates the cache enable signal and enables the cache memory 41. Further, the cache access control unit 44 delivers the store data as cache write data to the cache memory 41. The cache access control unit 44 delivers an address, which is indicated by the cache index entry signal and cache entry signal, to the cache memory 41 as a cache address. Thereby, the store data is written in the entry corresponding to the cache address in the cache memory 41.

In the above-described manner, the data in the rendering process unit 26 is stored in the cache memory 41.

Next, the refill operation is described with reference to FIG. 24. FIG. 24 is a block diagram of the pixel shader unit. “Refill” is an operation for reading out, when the cache memory 41 does not have data which is requested by the rendering process unit 26, this data from the local memory into the cache memory 41.

To start with, if the hit determination is missed in the cache management unit 45, in other words, if the hit entry number is all-bit zero, that is, if necessary data is not present in the cache memory 41, then the cache management unit 45 outputs the refill request enable signal, refill address and refill request ID to the request issuance control unit 46. Upon receiving these signals, the request issuance control unit 46 counts up the number of requests. In addition, the request issuance control unit 46 sends a refill request to the local memory 13 (i.e. outputs the refill request signal).

The local memory 13, which has received the refill request, outputs refill acknowledge signals to the cache management unit 45, to the cache access control unit 44 and to the request issuance control unit 46. Upon receiving the refill acknowledge signal, the cache access control unit 44 outputs the acknowledge ID to the cache management unit 45. Thereby, the cache management unit 45 recognizes that the refill request has exactly been received. After the refill acknowledge signal is output, the refill data is output from the local memory 13 to the cache access control unit 44. Then, in the same manner as in the store operation, the cache access control unit 44 replaces the refill data in the cache memory 41. The entry for use in the refill is determined by the LRF queue which has been described with reference to FIG. 20.

In the above-described manner, the data is refilled from the local memory 13 into the cache memory 41.

As has been described above, if the load/store instruction is issued, the cache management unit 45 executes the hit determination and checks the entries of the cache memory 41. If the hit determination is successfully executed, the load/store operation is carried out. If the hit determination is missed, the refill operation is carried out. The entry for use in the refill is determined by the LRF queue. Even in the case where the hit determination is missed, for example, if the request queue of the local memory 13 is full or there is no free entry in the cache memory 41, the refill request cannot be issued and the operation passes into the “wait” state. Thus, when the load/store instruction is issued, the data control unit 27 can take three states, as shown in FIG. 25. FIG. 25 is a state transition diagram of the data control unit 27.

As shown in FIG. 25, the data control unit 27 takes three states: an execution state (Exec), a wait state (Wait) and a fill state (Fill). The execution state is a state in which the load/store instruction is hit as a result of the hit determination, and the pixel shader unit is operating. The wait state is a state in which the load/store instruction is missed as a result of the hit determination, and the refill request is about to be issued. In this state, the pixel shader unit stalls. The fill state is a state in which the refill request is issued to the local memory 13. In this state, too, the pixel shader unit stalls.

The triggers, by which the above three states transition, are as follows. The numbers, listed below, accord with the numbers of state transitions indicated in FIG. 25.

1. No transition from the execution state: the load/store instruction is hit.

2. From the execution state to the wait state: the load/store instruction is missed.

3. From the wait state to the fill state: the refill request is issued.

4. From the fill state to the execution state: the refill acknowledge signal is returned.

5. No transition from the wait state: although the load/store instruction is missed, the refill request cannot be issued.

6. No transition from the fill state: the refill acknowledge signal is not returned.

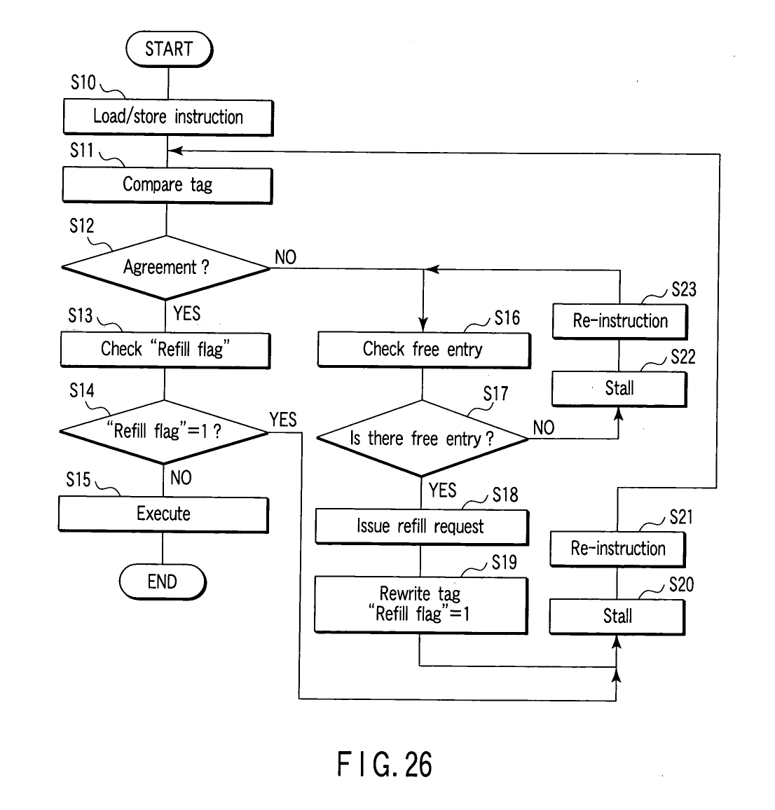

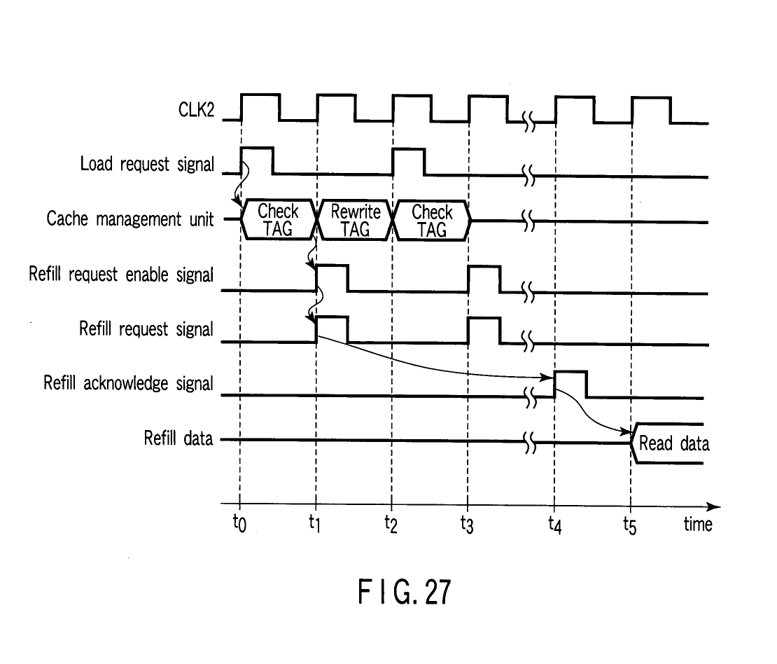

Next, the operation at the time when the load/store instruction is issued is described in detail with reference to FIG. 26 and FIG. 27. FIG. 26 is a flow chart of the operation of the data control unit 27, and FIG. 27 is a timing chart of various signals.

To start with, the load/store instruction is issued from the rendering process unit 26 (step S10). In other words, the load request signal is issued at time point t0 in FIG. 27.

In response to the load request signal, the cache management unit 45 executes the hit determination (step S11). To be more specific, the cache management unit 45 compares the requested address and the tag T in the status flag.

If the tag and the address agree (step S12), then the cache management unit 45 checks the refill flag R in the status flag (step S13). If the refill flag R is “0” (step S14), the “replace” relating to the associated entry is completed, so the load/store instruction is executed by using the associated data (step S15).

If the address and the tag T disagree in step S12, that is, if the load/store instruction is missed, it is checked whether there is a refill request issuable entry (step S16). If there is a refill request issuable entry, the cache management unit 45 issues the refill request (refill request enable signal, time point t2) (step S18). In addition, the request issuance control unit 46 outputs the refill request signal to the local memory 13.

In the next cycle, the cache management unit 45 rewrites the tag T in the status flag of the associated entry to the information relating to the refill data, and sets the refill flag R at “1” (step S19, time point t2). Then, this load/store instruction stalls (step S20). The stall continues until the refill acknowledge signal is returned from the local memory 13. In the stall state, the load/store instruction is issued once again (step S21). Then, since address and tag T agree (step S12) in the hit determination (step S11), the refill flag R is checked (step S14). If the refill acknowledge signal is returned from the local memory 13, the refill flag R would become “0”. Accordingly, the control process advances to step S15. However, if the refill acknowledge signal is not returned from the local memory 13, the refill flag R would remain “1” and the control process advances to step S20 and the stall continues.

If the refill request issuable entry is absent in step S17, the stall continues until a free entry becomes available (step S22), and the load/store instruction is issued once again (step S23). If the stall is continued, any of the entries will become available at last as a refill request issuable one, and thus the refill request is issued to the refill request issuable entry (step S18).

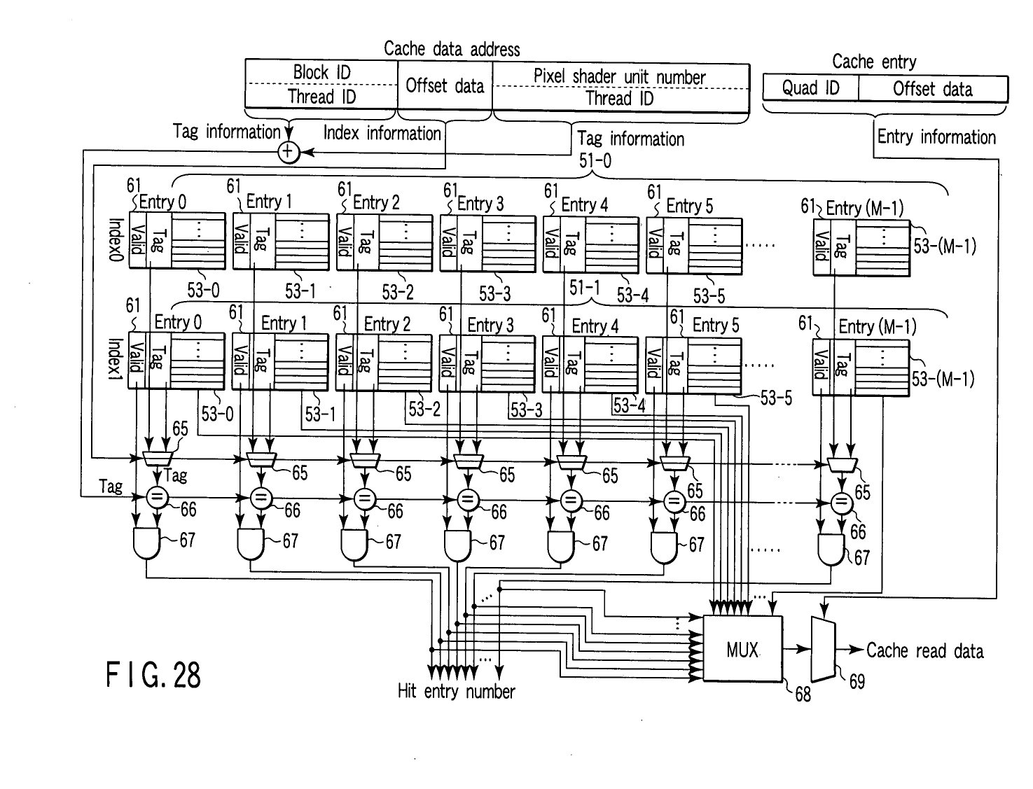

Next, referring to FIG. 28, a description is given of the structure for the hit determination in the cache management unit 45 and the method for the hit determination. FIG. 28 is a block diagram of a part of the cache management unit 45, and the cache memory 41.

As shown in FIG. 28, the cache management unit 45 includes, in addition to the memories 61, selection circuits 65, comparison circuits 66 and AND gates 67, which are provided in association with the memories 53-0 to 53-(M−1). The cache memory 41 includes selection circuits 68 and 69 and a memory 70.

In order to execute the hit determination, the cache data address signal is input to the cache management unit 45. The cache data address includes the block ID, offset data and pixel shader unit number in the frame buffer mode. The block ID and pixel shader unit number indicate the tag information relating to the object data, and the offset data indicates the index information. In the memory register mode, the cache data address includes the thread ID and offset data. The thread ID indicates the tag information, and the offset data indicates the index information. The index information is a signal that indicates which of the memories 51-0 and 51-1 is to be accessed. To begin with, based on the index information of the address signal, the selection circuit 65 selects one of the memories 51-0 and 51-1 in the cache memory 41. Then, each of the comparison circuits 66 compares the tag T corresponding to the memories 53-0 to 53-(M−1), i.e. entries 0 to (M−1), in the memory 51-0 or memory 51-1 selected by the selection circuit 65, with the tag information that is obtained from the cache data address. If the tag T and the tag information agree, the comparison circuit 66 outputs “1”. If they do not agree, the comparison circuit 66 outputs “0”. Further, each of the AND gates 67 executes an AND operation between the valid flag V corresponding to the memories 53-0 to 53-(M−1) in the memory 51-0 or memory 51-1, which is selected by the selection circuit 65, and the output of the associated comparison circuit 66. The result of the AND operation becomes the signal hit entry number. That any one of the bits in the hit entry number is “1” means that the associated data is stored in any one of the memories 53-0 to 53-(M−1), which corresponds to the bit.

The selection circuit 68 selects any one of the memories 0 to (M−1), that is, any one of the entries 0 to (M−1), on the basis of the hit entry number. For example, in the case where the hit entry number is (10000 . . . ), this means that the associated data is stored in the entry 0, and thus the entry 0 is selected. In the example of the present embodiment, as described above, the cache memory 41 executes data transmission/reception with the outside in units of a sub-entry. Thus, the selection circuit 69 selects any one of the L-number of sub-entries 0 to (L−1), which is included in the entry selected by the selection circuit 68, on the basis of the cache entry. As described above, the cache entry includes the quad ID and offset data. The cache entry becomes entry information which is indicative of which of the sub-entries 0 to (L−1) is to be accessed in each entry, 0 to (M−1). The data of the amount corresponding to 1 sub-entry that is selected by the selection circuit 69 becomes the cache read data.

As has been described above, according to the graphic processor of the first embodiment of the invention, the following advantageous effect (1) can be obtained.

(1) The hardware in the graphic processor can be reduced (Part 1).

According to this embodiment, the cache management unit 45 stores the refill flag R and tag T as status flags. When the load/store instruction is missed in the hit determination, the cache management unit 45 first issues the refill request and rewrites the tag T. At this time point, the replace is yet to be started. That is, the information of tag T disagrees with the data in the entry corresponding to the cache memory 41. Thus, the cache management unit 45 executes management as to whether both agree or not, on the basis of the refill flag R. As a result, the hardware of the graphic processor can be reduced, and the manufacturing cost can be reduced. This point will be explained below in detail.

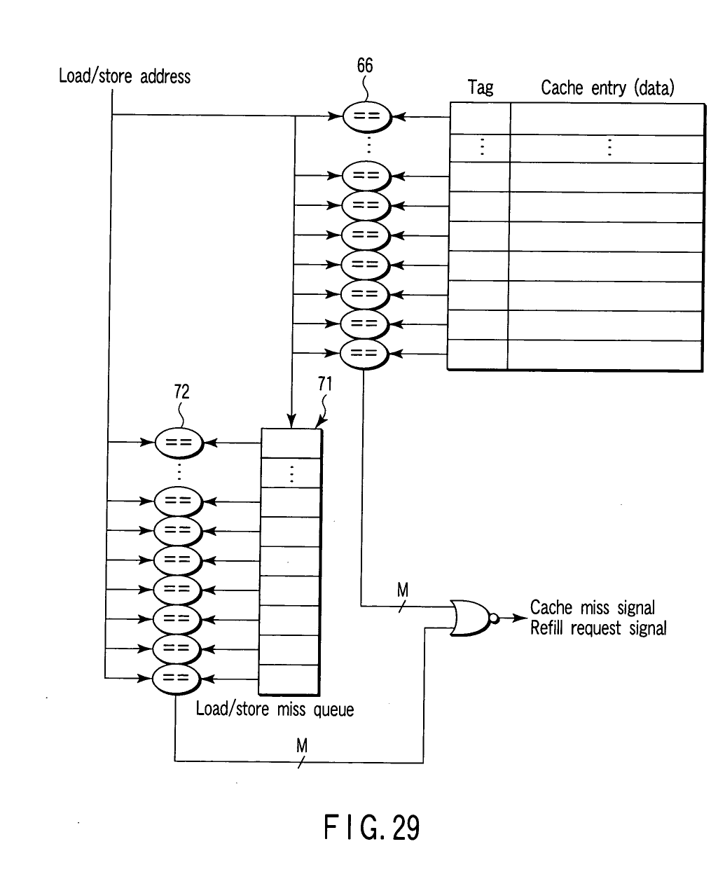

FIG. 29 is a block diagram showing the structure of the cache management unit 45 which is thinkable in the case of not using the refill flag R. In addition to the structure of the present embodiment, the cache management unit 45 further includes a load/store miss queue 71 and comparators 72. The load/store miss queue 71 stores load/store instructions for which “replace” is not completed.

In FIG. 29, if the load/store instruction is issued, the hit determination is first executed. Specifically, the comparator 66 compares the input address and the tag T. If both do not agree, the comparator 72 further compares the input address and the load/store miss queue 71. If the comparator 72 determines that both do not agree, the load/store instruction is stored in the load/store miss queue 71 and the refill request is issued. When the comparison results in both comparators 66 and 72 show “miss”, the refill request is issued. If the refill request is issued and the replace is completed, the tag T is rewritten at this time point. In other words, the information indicated by the tag T and the data in the cache memory 41 always agree.

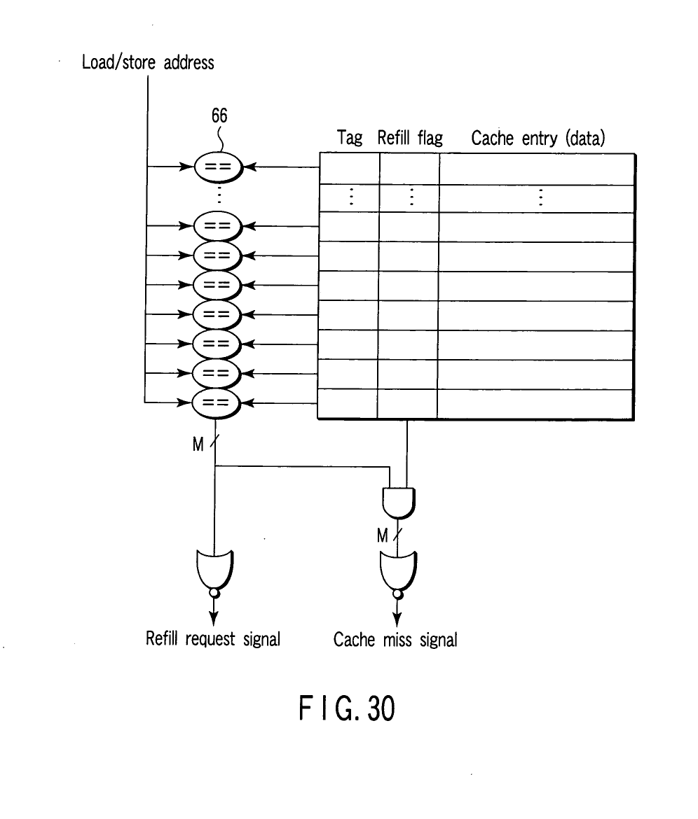

On the other hand, FIG. 30 shows a simplified structure of the cache management unit 45 according to the present embodiment. In this embodiment, if the address and the tag T do not agree in the comparator 66, the refill request is issued and the tag T is rewritten at this time point. Further, the refill flag R is set at “1”. Thereafter, replace is executed at some timing. If the replace is completed, the refill flag R returns to “0”. If the address and tag T agree in the comparator 66, it is checked whether the entry is in the process of replace or not, on the basis of the refill flag R. If the replace is not completed, the load/store instruction is stalled. If the replace is completed, the load/store instruction is executed.

Since the tag T is rewritten in coincidence with the issuance of the refill request, the load/store miss queue 71 in FIG. 29 is needless. Further, whether the replace is completed or not is managed by the refill flag, and thus the comparator 72 in FIG. 29 is also needless. As a result, compared to the structure shown in FIG. 29, the hardware can be reduced, and the manufacturing cost can be reduced.

In the present embodiment, as shown in FIG. 27, the load/store instruction is issued only once in two cycles. Thus, the tag T can be rewritten in coincidence with the issuance of the refill request. The reason is that it is necessary to execute the read-out of the tag and hit determination in the first cycle and to execute the rewrite of the tag in the next cycle, as shown in FIG. 27.

The calculation method of the address signal is not limited to the method described in the above embodiment. The method is variable depending on the number of stamps in the block, or the number of pixel shader units 24. The internal structure of the address signal is not limited to the structure shown in FIG. 13 or FIG. 14. As shown in FIG. 28, it should suffice if the address signals include the tag information, index information and entry information. Further, in the case where the cache memory 41 includes only one of the memories 51-0 and 51-1, the index information is needless. If the data transfer is executable with the entry size of the cache memory 41, the entry information is needless. In this case, it should suffice if the address generating unit 40 generates only the tag information. The address generating unit 40 needs to be furnished with information for generating the above address signals. In the present embodiment, as this information, the offset data, XY coordinates, thread ID, quad ID, sub-pass ID and buffer mode signal are delivered, as shown in FIG. 12. However, these signals are merely examples, and the signals are not limited if they are usable for generating the tag information and other necessary addresses. In addition, in this embodiment, the tag T has been described and exemplified as the information corresponding to parts of the thread IDs and pixel shader unit numbers. However, it should suffice if the information that is used as the tag T can identify data, and the information may be other than the thread ID and pixel shader unit number.

Next, a graphic processor according to a second embodiment of the invention is described. This embodiment relates to the write-back operation in the graphic processor, which has been described with reference to the first embodiment.

The cache management unit 45 according to the present embodiment controls the write-back operation, in addition to the control described in connection with the first embodiment. As has been described with reference to FIG. 21, “write-back” is the operation of writing the data, which is present in the cache memory 41, into the local memory 13. When the store instruction is issued from the rendering process unit 26, the data is written only in the cache memory 41. In short, only the data in the cache memory 41 is updated. As a result, the data in the cache memory 41 does not agree with the data in the local memory 13. In order to avoid loss of the data in the cache memory 41 in this state, the write-back is executed. In the description below, the state in which the updated data is stored only in the cache memory 41 is referred to as “dirty”.

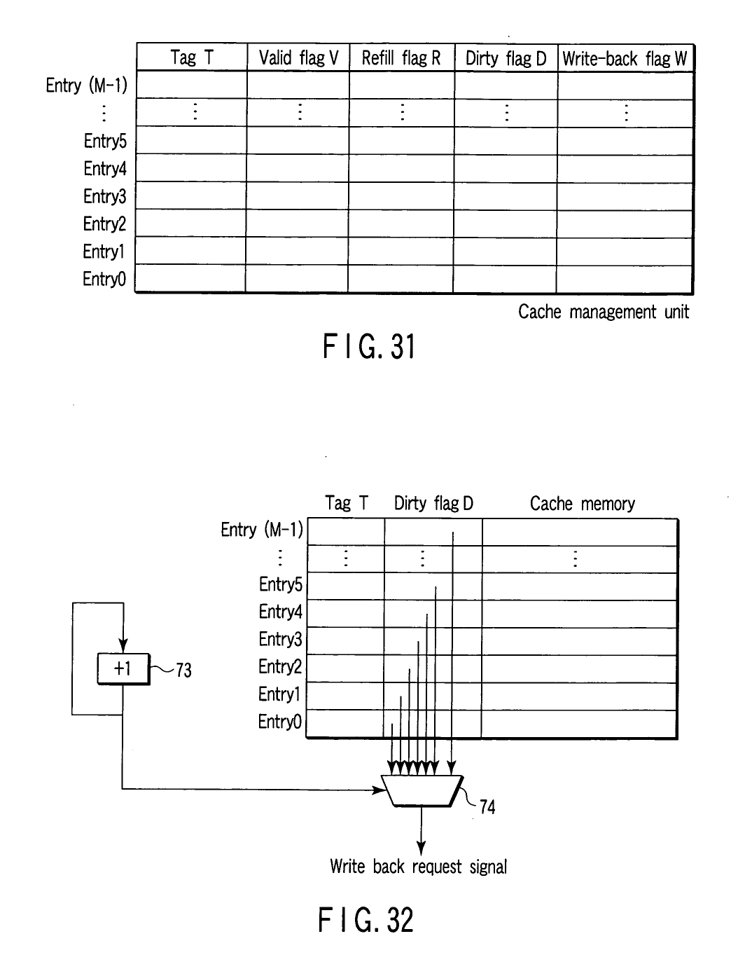

FIG. 31 is a conceptual view of the memory 61 which is included in the cache management unit 45. The memory 61 stores, as status flags, the tag T, the valid flag V, the refill flag R, a dirty flag D and a write-back flag W. The dirty flag D indicates whether the associated entry is dirty or not, that is, indicates that data is written in the entry from the rendering process unit 26. The dirty flag D is asserted until the read-out of the write-back data is started. The write-back flag W indicates whether the associated entry is issuing the write-back request or not. The write-back flag W is asserted from when the write-back request is issued to when the read-out of the write-back data is started.

FIG. 32 is a block diagram of the structure for issuing the write-back request in the cache management unit 45. As shown in FIG. 32, the cache management unit 45 includes a counter 73 and a selection circuit 74. The selection circuit 74 selects the dirty flag D of the entry corresponding to the count number in the counter 73.

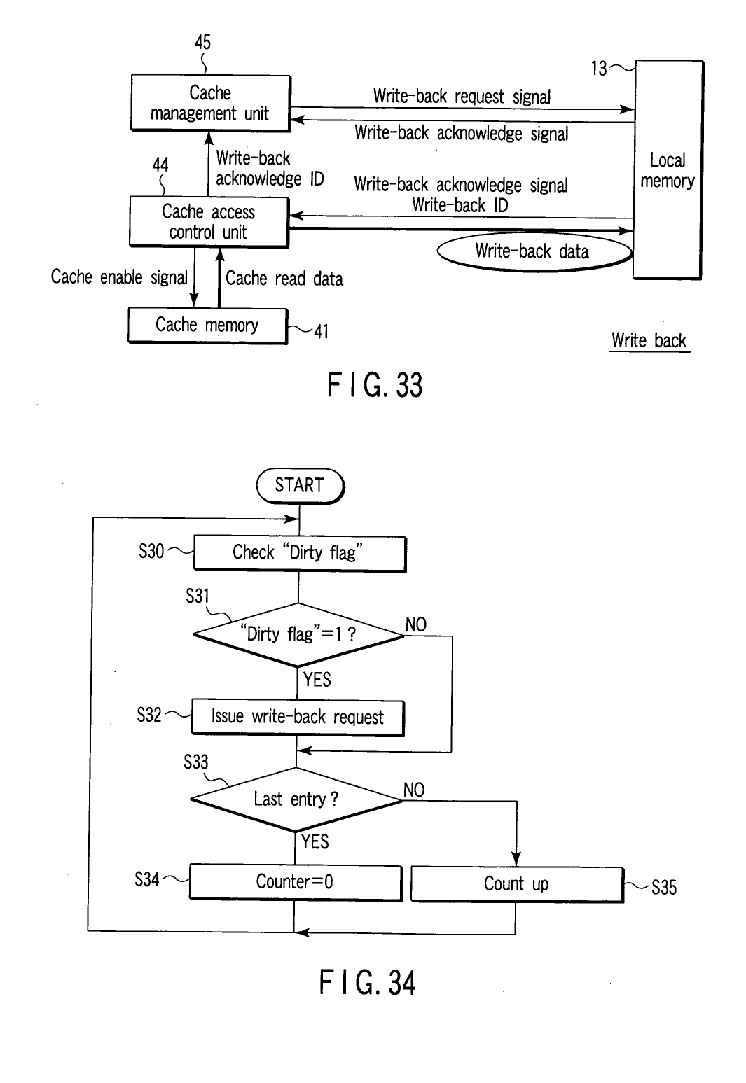

Next, the write-back operation is described with reference to FIG. 33. FIG. 33 is a block diagram of the pixel shader unit.

To start with, a write-back request signal is output from the cache management unit 45 to the local memory 13. If the write-back request is entered in the local memory 13, a write-back acknowledge signal is output from the local memory 13 to the cache management unit 45 and cache access control unit 44, and a write-back ID is output to the cache access control unit 44.

Then, based on the write-back ID, the cache access control unit 44 reads out data (cache read data) from the cache memory 41. The cache access control unit 44, which has read out the data from the cache memory 41, returns a write-back acknowledge ID to the cache management unit 45, and writes the read data in the local memory 13 as write-back data. Then, responding to the write-back acknowledge ID, the cache management unit 45 de-asserts the dirty flag D and write-back flag W of the associated entry (i.e. set these flags at “0”).

Next, the method of selecting the entry, for which the write-back is executed, in the cache management unit 45 is described with reference to a flow chart of FIG. 34. To start with, the cache management unit 45 checks the dirty flag D of the entry corresponding to the current counter value of the counter 73 (step S30). If the dirty flag D=“1” (step S31), the write-back request is issued for the associated entry (step S32). If the dirty flag D=“0”, the write-back request is not issued. If the counter value indicates the value corresponding to the last entry (step S33), the counter value is reset (step S34) and the control process returns to step S30. If the counter value does not indicate the value corresponding to the final entry (step S33), the counter 73 counts up and the control process returns to step S30.

In short, with respect to all the entries 0 to 2(M−1) in the cache memory 41, the dirty flags D are checked successively, and the write-back request is issued if the dirty flag D is asserted.

The structure and operation in the other respects are the same as in the first embodiment.

As has been described above, according to the graphic processor of the second embodiment of the invention, the following advantageous effects (2) and (3) can be obtained in addition to the advantageous effect (1) that has been described in connection with the first embodiment.

(2) The hardware in the graphic processor can be reduced (Part 2).

In the conventional write-back method, in usual cases, the write-back data is temporarily stored in the buffer memory, and then the write-back data, which is stored in the buffer memory, is written into the local memory at a proper timing. This method is adopted in order to avoid the occurrence of the condition that the refill is disabled until the completion of the write-back, in the case where the issuance of the refill request becomes necessary during the write-back. According to this method, by saving the data in the buffer, the refill request relating to the associated entry can be issued even during the write-back. In addition, the write-back is executed in response to some trigger from the outside of the cache management unit 45, or executed at the same time as the storing of the data in the cache memory.

By contrast, in the present embodiment, the cache management unit 45 stores the dirty flag D as the status flag, and executes management as to which of the cache entries is dirty. The cache management unit 45 always monitors the dirty flags D and, as long as any one of the entries is dirty and the write-back request issuance is possible, executes the write-back at this timing. Thus, the probability of presence of a dirty entry is remarkably lower than in the prior art. Hence, even if any one of the entries is in the write-back operation, it is highly possible that there is some other entry for which the refill request can be issued. Accordingly, unlike the prior art, there is no need to save the data in the buffer, and the buffer is dispensed with. Therefore, the hardware can be reduced and the manufacturing cost can be reduced.

(3) The cache memory can efficiently be used (Part 1).

As has been described above in connection with the advantageous effect (2), even if there is no request from the outside, if the write-back request can be issued, the write-back is executed at this time point. Therefore, the entries in the cache memory 41 can effectively be used.

In the case where an eDRAM (embedded DRAM) is used for the local memory 13 and its latency is long, write-back may be executed at a time when the write-back is possible, as in the present embodiment. Thereby, the possibility of presence of a dirty entry can effectively be reduced, and the performance of the graphic processor can be enhanced.

In the case where the entry size of the cache memory 41 is large, the advantageous effect of the present embodiment is particularly remarkable. The reason is that as the entry size increases, the buffer size that is needed in the conventional method increases. Thus, the effect of reduction in area is conspicuous.

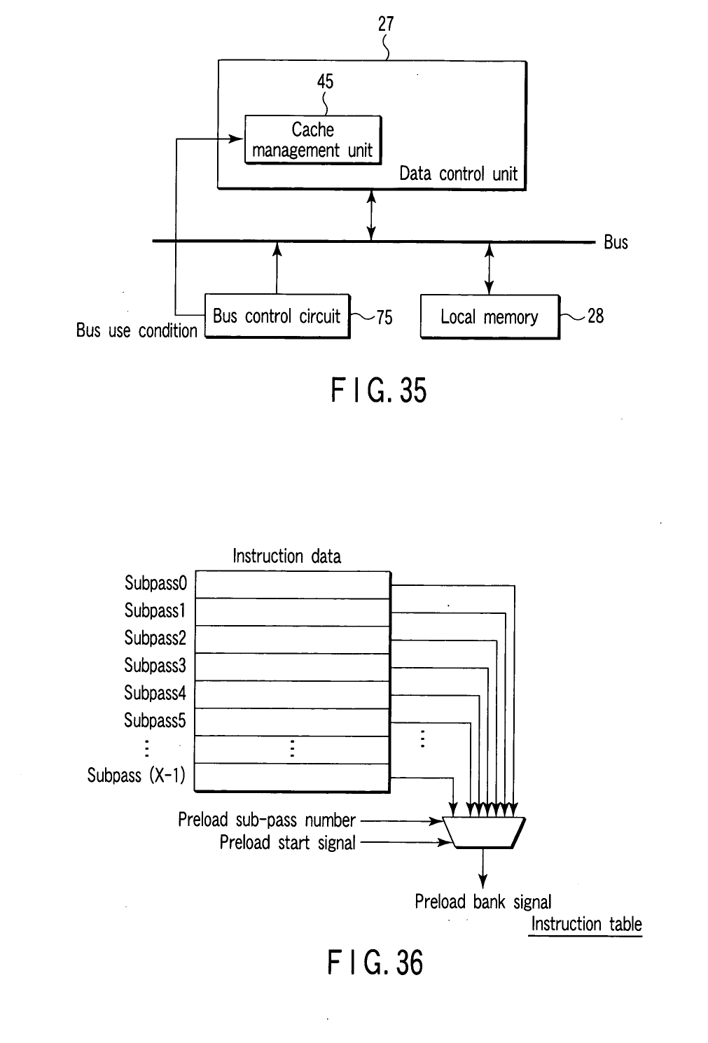

As shown in FIG. 35, the cache management unit 45 may receive the condition of the bus as data from a bus control circuit 75. The bus control circuit 75 controls the connection between the respective circuit blocks by the bus. In order to execute the write-back, it is necessary that the bus between the data control unit 27 and the local memory is not used. Thus, the cache management unit 45 receives the current condition of use of the bus from the bus control circuit 75, and issues the write-back request when the non-use of the bus is recognized. Thereby, the efficiency of use of the bus can be enhanced.

Next, a graphic processor according to a third embodiment of the invention is described. This embodiment relates to the preload operation in the graphic processor which has been described in connection with the first and second embodiments.

The preload control unit 43 shown in FIG. 10 controls the preload operation. The preload control unit 43 includes the preload address generating unit 47, preload storage unit 48, sub-pass information management unit 49 and address storage unit 50. The preload storage unit 48 manages the thread, for which the preload request is issued. The preload storage unit 48 receives the preload request in units of a thread from the instruction control unit 25. At this time, the preload storage unit 48 simultaneously receives and stores the XY coordinates of the thread, the thread ID and the sub-pass number of the sub-pass to be executed. The preload storage unit 48 includes a memory having a plurality of entries, and accumulates preload requests in the entries of the memory. The preload requests are issued in a priority order from the entry with the lowest number. If the entry for which the preload request is issued is determined, a preload start signal and a preload sub-pass number are output to the sub-pass information management unit 49. The preload start signal indicates the start of the preload relating to a new thread, and the preload sub-pass number is a sub-pass number of the sub-pass that is associated with the preload.

Next, the sub-pass information management unit 49 is described. The sub-pass information management unit 49 executes a control for storing information of the buffer used in the sub-pass, and a control for outputting parameters for preload. In order to perform information management of the buffer, the sub-pass information management unit 49 includes an instruction table as shown in FIG. 36. The respective entries of the instruction table are associated with the respective sub-passes. Each time the load/store instruction is issued, the sub-pass information management unit 49 writes the information (instruction data) corresponding to this instruction into the instruction table. This information is delivered from the instruction control unit 25 as a buffer bank select signal and a buffer mode signal. These signals include, for example, information as to whether the local memory is used as a frame buffer or a memory register, and information relating to a base address (first address) of the data storage area.

In addition, when the preload instruction is issued, the sub-pass information management unit 49 reads out from the instruction table the information relating to the sub-pass which is designated by the preload start signal and the preload sub-pass number. The sub-pass information management unit 49 outputs the data, which is read out of the instruction table, to the preload address generating unit 47 as the preload bank signal. In addition, the preload enable signal is asserted.

Next, the preload address generating unit 47 is described. The preload address generating unit 47 generates address signals necessary for preload. The method of generating addresses is the same as with the address generating unit 40 which has been described with reference to the first embodiment (see FIG. 13 and FIG. 14). The signals for the address calculations (the XY coordinates for preload, the thread ID for preload, the preload bank signal) are always delivered from the preload storage unit 48 and sub-pass information management unit 49. In this state, if the preload enable signal is asserted, the preload address generating unit 47 starts the calculation of the addresses in response to the assertion of the preload enable signal. The obtained preload address and preload enable signal are output to the address storage unit 50.

Next, the address storage unit 50 is described. The address storage unit 50 is a queue for storing, when the issuance of a preload instruction is stalled, the address relating to this instruction. In the case where there is no vacancy in the request queue of the local memory 13, in the case where there is no entry in the cache memory 41, which can issue a preload request, and in the case where there is a refill request in the request issuance control unit 46, which waits for issuance, the preload instruction is stalled and the preload enable signal is de-asserted. These information items are delivered from the request issuance control unit 46 as a refill ready signal and a request condition signal.

In addition, the address storage unit 50 outputs to the cache management unit 45 the data necessary for hit determination relating to the preload instruction.

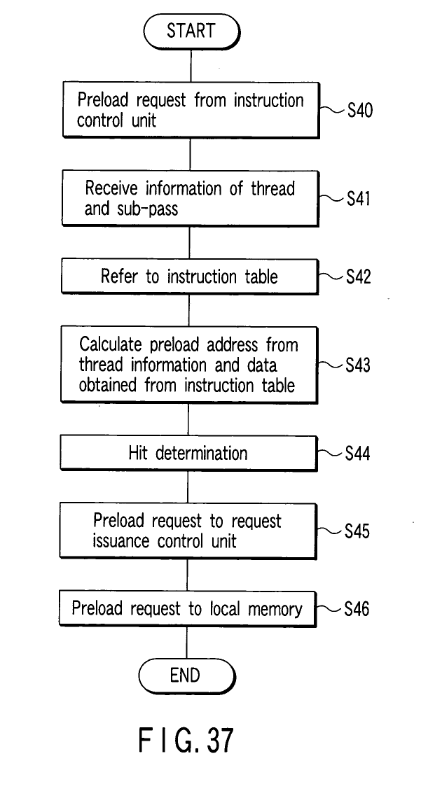

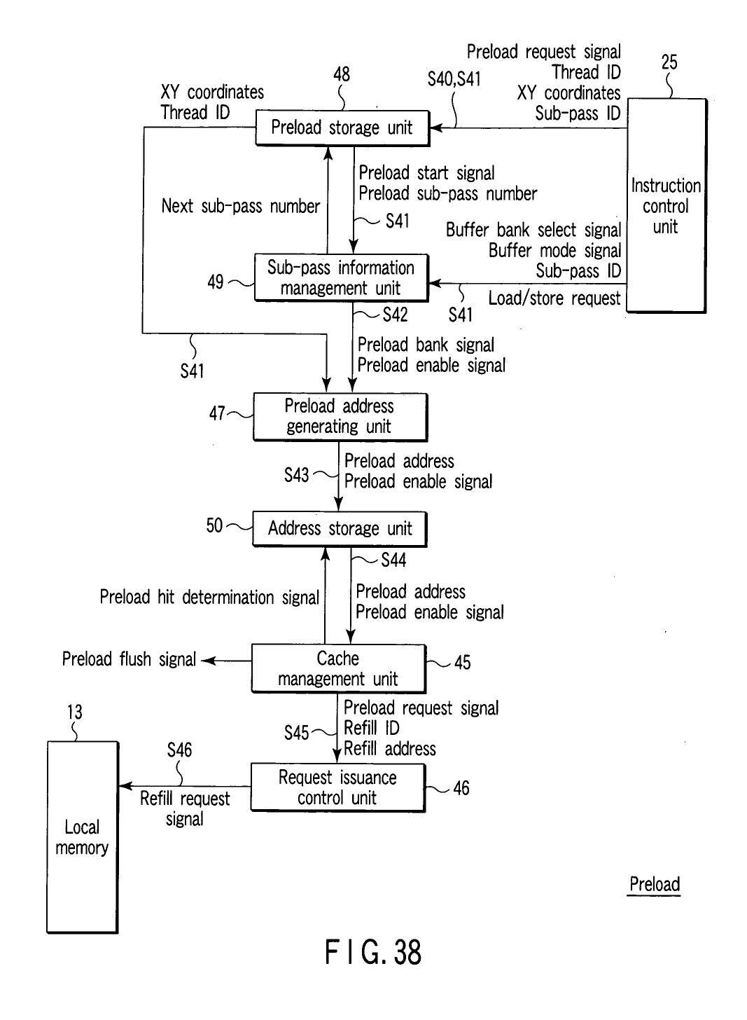

Next, the preload operation of the graphic processor according to the present embodiment is described with reference to FIG. 37 and FIG. 38. FIG. 37 is a flow chart illustrating the preload operation, and FIG. 38 is a block diagram of the data control unit 27 which is associated with the steps in FIG. 37.

To start with, the instruction control unit 25 issues a preload request to the preload storage unit 48 (step S40). At this time, the preload storage unit 48 receives thread information (XY coordinates, thread ID, sub-pass ID), in addition to the preload request signal, from the instruction control unit 25 (step S41).

The preload storage unit 48 outputs the preload start signal and preload sub-pass number to the sub-pass information management unit 49. Based on the received preload start signal and preload sub-pass number, the sub-pass information management unit 49 reads out the information relating to the load/store instruction from the instruction table (step S42). The read-out information (preload bank signal) is output to the preload address generating unit 47. This information relating to the load/store instruction is the information that is stored in the instruction table of the sub-pass information management unit 49 when the load/store instruction is issued in the instruction control unit 25. Further, the sub-pass information management unit 49 asserts the preload enable signal. In addition, the preload storage unit 48 outputs the thread information (XY coordinates, thread ID) to the preload address generating unit 47.

Subsequently, the preload address generating unit 47 calculates the preload address by using the information relating to the load/store instruction that is delivered from the sub-pass information management unit 49, and the thread information that is delivered from the preload storage unit 48 (step S43). The preload address generating unit 47 outputs the preload address, which is obtained by the calculation, to the address storage unit 50. In addition, the preload address generating unit 47 asserts the preload enable signal and outputs it to the address storage unit.

Further, these information items are output from the address storage unit 50 to the cache management unit 45. The cache management unit 45 executes hit determination (step S44). The hit determination in step S44 is a process for determining whether the data to be preloaded is already present in the cache memory 41. As has been described in connection with the refill operation in the first embodiment, if the result of the hit determination for preload is “miss”, the cache management unit 45 issues the preload request signal. In addition, the cache management unit 45 issues the refill ID and refill address, and outputs them, together with the preload request signal, to the request issuance control unit 46 (step S45). If the hit determination is finished, the cache management unit 45 asserts a preload hit determination signal, regardless of “miss/hit”, and de-asserts the preload information in the address storage unit 50. The preload hit determination signal is a signal indicative of whether the hit determination in the cache management unit 45 is finished or not.

The request issuance control unit 46 formally issues the preload request to the local memory 25 (i.e. the refill request signal is output; step S46). Thereafter, in the same manner as the refill, the data in the local memory is preloaded into the cache memory 41.

As has been described above, according to the graphic processor of the third embodiment of the invention, the following advantageous effect (4) can be obtained in addition to the advantageous effects (1) to (3) that have been described in connection with the first and second embodiments.

(4) The cache memory can efficiently be used (Part 2).

In the graphic processor according to the present embodiment, the preload address is calculated by using the thread information and the information relating to the load/store instruction. As the thread information, the X coordinate, Y coordinate and thread ID are received from the preload storage unit 48. In addition, as the information relating to the load/store instruction, the data that is to be referred to in the configuration register, offset and base address are received from the sub-pass information management unit 49. By using these information items, the preload address can be calculated more exactly than in the prior art. To be more specific, the value of WIDTH is understood from the information relating to the load/store instruction. Depending on the value of WIDTH, the block ID varies even if the XY coordinates are the same. Further, the first address of the address signal is understood. Besides, the value of offset and the use mode of the memory (i.e. frame buffer mode or memory register mode) are understood. Accordingly, the preload address generating unit 47 can obtain all the information that is necessary for the address calculation formula, which has been described in connection with the first embodiment.

The preload is the process for reading out, in advance, data that is to be needed in the rendering process unit 27, from the local memory into the cache memory 41. Thus, there may be a case in which even though data is preloaded, the data would not actually be used.

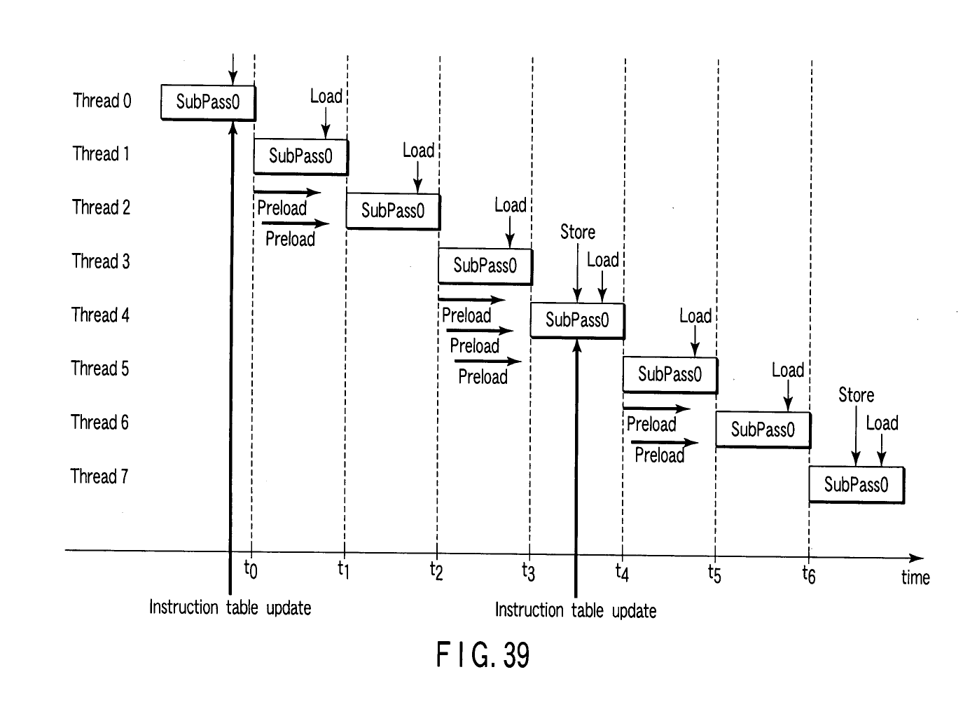

In the present embodiment, however, by using the information that is delivered when the load/store instruction is issued, the preload address is calculated, that is, it is determined which of data is to be preloaded. Thus, the probability of use of the preloaded data increases. In other words, at the time of the hit determination that has been described in connection with the first embodiment, the probability of hit of preload data is increased. The reason for this is that since the instruction sequence is used for processing a plurality of threads, if an instruction (sub-pass) to be executed is understood, it becomes possible to find an address at which the data to be used by an arbitrary thread is stored. Thus, when a different thread, for which the same sub-pass as in the previously executed sub-pass is executed, is activated, preload is executed based on the previously traced information. This being the case, as shown in FIG. 39, in order to calculate the preload address by the method according to the present embodiment, it is necessary that the load/store instruction be issued with respect to any one of the threads. In FIG. 39, preload cannot be executed with respect to sub-pass 0 relating to thread 0. If a load/store instruction is issued for the sub-pass 0 relating to thread 0, the instruction table is updated at this time point. Thus, preload is enabled with respect to the next thread 1.

Hence, useless preload operations can be reduced, and at the same time, useless occupation of entries in the cache memory 41 can be suppressed. Therefore, the cache memory 41 can efficiently be used, and the performance of the graphic processor can be improved.

Next, a graphic processor according to a fourth embodiment of the invention is described. In this embodiment, in the graphic processors that have been described in connection with the first to third embodiments, the cache management unit 45 restricts the request issuance of entries.

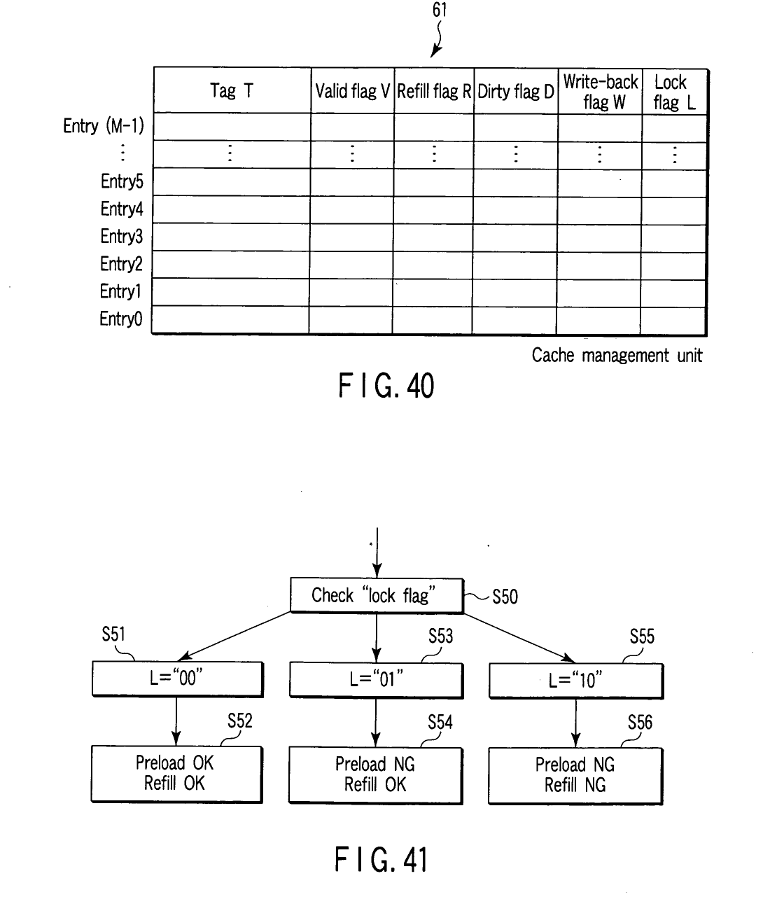

FIG. 40 is a conceptual view of the memory 61, and shows the states of status flags which are included in the cache management unit 45. As shown in FIG. 40, the cache management unit 45 according to this embodiment stores a lock flag L as a status flag, in addition to the tag T, valid flag V, refill flag R and write-back flag W. The lock flag L is 2-bit data, and L=“00” indicates a free state of the associated entry in the cache memory 41. In this state, the entry is capable of issuing either a preload request or a refill request. L=“01” indicates a state in which the entry is issuing the preload request. In this state, the entry can issue the refill request but cannot issue the preload request. L=“10” indicates that the execution thread is using the entry. In this state, the entry can issue neither the refill request nor the preload request.

Thus, when the refill request and preload request are issued, the cache management unit 45 checks the lock flag L of the status flag, as shown in FIG. 41 (step S50). When L=“00” (step S51), one of the refill request and preload request is issued (step S52). When L=“01” (step S53), the refill request can be issued but the preload request is stalled (step S54). When L=“10” (step S55), each of the requests is stalled (step S56).

As described above, the cache entry can take the following eight states in accordance with the lock flag L, refill flag R and write-back flag WB.

1. Initial state (Init: L=“00”, R=“0”, WB=“0”)

The entry is in the free state, and each of the preload request and refill request is acceptable.

2. Ready state (Rdy: L=“01”, R=“0”, WB=“0”)

Preload is completed, and the execution of the thread, which uses the associated entry, is being awaited.

3. Execution state (Exec: L=“10”, R=“0”, WB=“0”)

In this state, the thread, which is being executed, is using the associated entry.

4. Non-use state (NoWake: L=“00”, R=“1”, WB=“0”)

In this state, the associated thread is executed during the preload, but there is no access to the associated entry and the sub-pass is finished.

5. Preload state (PreLd: L=“01”, R=“1”, WB=“0”)

In this state, the preload request is being issued.

6. Fill state (Fill: L=“10”, R=“1”, WB=“0”)

In this state, the refill request is being issued due to a cache miss, or the thread using the associated entry is executed while the preload request is being issued.

7. Write-back state (WrB: L=“00” or “01”, R=“0”, WB=“1”)

In this state, the write-back request is being issued.

8. Use state (WrBExec: L=10, R=“0”, WB=“1”)

The write-back state transitions to the use state if an access occurs or the use thread is executed in the write-back state. In the use state, the execution thread is changed while the write-back request is being issued, and the associated entry is used by the execution thread.

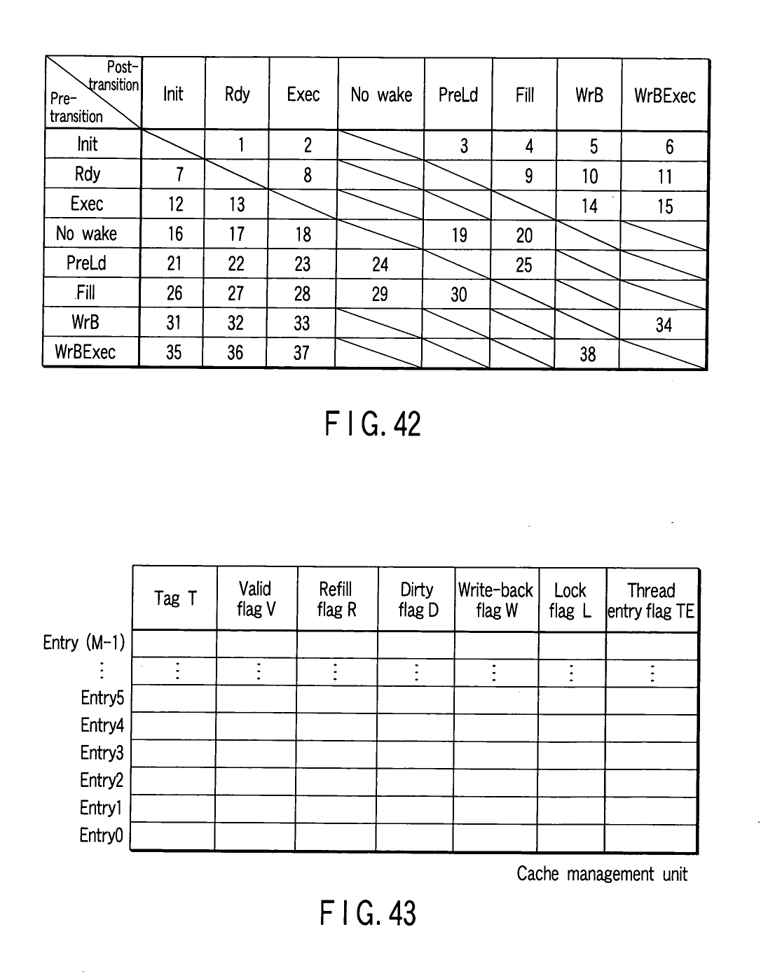

Next, the conditions for transitions between the respective states are explained with reference to FIG. 42. In the table of FIG. 42, pre-transition states are listed vertically, and post-transition states are listed horizontally. Numerals in the table indicate state-change events, which are described below.

1. When the preload hits the entry.

2. When the load/store instruction is hit.

3. When the preload is mishit and the preload request is issued.

4. When the load/store instruction is mishit and the refill request is issued.

5, 10. When the execution of write-back is started.

6. When the execution of the sub-pass is started in coincidence with the start of execution of write-back.

7. When the preload of the execution thread is executed but the sub-pass is finished without the load/store access.

8. When the execution of the thread using the preloaded entry is started or the load/store instruction is hit.

9. When refill is executed for the preloaded entry due to load/store instruction mishit.

11. When the execution of the sub-pass is started or the load/store instruction is hit, in coincidence with the start of execution of write-back.

12. When the end instruction or yield instruction is executed, and there is no preload request of another thread.

13. When the end instruction or yield instruction is executed, and there is a preload request of another thread.

14. When the end instruction or yield instruction and the write-back are executed at a timing subsequent to the sub-pass start.

15. When the write-back is started immediately after the sub-pass is started.

16, 22. When the preload is completed.

17. When the completion of preload and the hit of another preload have occurred at the same time.

18. When the completion of preload and the hit of the load/store instruction have occurred at the same time.

19. When the preload instruction is hit (this, however, should occur while the preload request is being issued).

20. When the load/store instruction is hit (this, however, should occur while the preload request is being issued).

21. When the preload of the execution thread is executed but the sub-pass is finished without the load/store access, and the preload is finished at the same time.

23. When the completion of the preload and the sub-pass start have occurred at the same time.

24. When the preload of the execution thread is executed but the sub-pass is finished without the load/store access, and the preload is still being issued.

25. When the execution of the thread using the entry that is being preloaded is started, or the load/store instruction is hit.

26. When the preload state has transitioned to the fill state but the preload is completed at the same time as the sub-pass is finished, without the load/store access, and when there is no preload request of another thread.

27. When the preload state has transitioned to the fill state but the preload is completed at the same time as the sub-pass is finished, without the load/store access, and when there is a preload request of another thread.

28. When the refill is completed.

29. When the preload state has transitioned to the fill state but the sub-pass is finished without the load/store access, and when the preload is yet to be completed and there is no preload request of another thread.

30. When the preload state has transitioned to the fill state but the sub-pass is finished without the load/store access, and when the preload is yet to be completed and there is a preload request of another thread.

31. When the write back is completed at L=“00”.

32. When the write back is completed at L=“01”.

33. When the load/store instruction is hit at the same time as the end of the write-back.

34. When the thread using the entry, which is in the process of write-back, is executed.

35. When the completion of write-back and the end instruction or yield instruction have occurred at the same time, and there is no preload request of another thread.

36. When the completion of write-back and the end instruction or yield instruction have occurred at the same time, and there is a preload request of another thread.

37. When the write back is completed at L=“10”.

38. When the sub-pass is finished by the end instruction or yield instruction.

According to the above-described conditions, the cache entry undergoes state transitions.

As has been described above, according to the graphic processor of the fourth embodiment of the invention, the following advantageous effect (5) can be obtained in addition to the advantageous effects (1) to (4) that have been described in connection with the first to third embodiments.

(5) The cache memory can efficiently be used (Part 3).

In the graphic processor according to this embodiment, the lock flag L having a plurality of levels is provided as one of the status flags. The lock flag L restricts the request issuance of the entry of the cache memory 41. To be more specific, the lock flag L includes three levels (“00”, “01”, “10”). L=“00” is the state in which the entry is not locked and the entry of the cache memory 41 can freely issue the preload request and refill request. L=“01” is the state in which the entry is weakly locked and the entry of the cache memory 41 is prohibited from issuing the preload request. L=“10” is the state in which the entry is firmly locked and the entry of the cache memory 41 is prohibited from issuing either the preload request or the refill request.

The preloaded data, as described above, is the data that is read out into the cache memory 41 prior to the actual process. On the other hand, the refilled data is the data that is needed by the load/store instruction. Thus, the importance of the data replaced in the cache memory 41 by the refill is higher than the data read out by the preload, and the former has higher necessity for protection.

In the present embodiment, the lock flag L is provided in the status register, and the entry in which refill is executed is firmly locked and the data in this entry is prevented from being rewritten by preload or further refill. Thus, necessary data can be prevented from being lost from the cache memory 41, and the cache memory 41 can efficiently be used.

As regards the data that is read out by preload, the entry is weakly locked, for example, unless and until the associated sub-pass is finished. Thereby, rewrite of the preloaded data is prevented. Thus, the preload data can efficiently be used. As a result, the cache memory 41 can efficiently be used, and the performance of the graphic processor can be enhanced.

Next, a graphic processor according to a fifth embodiment of the invention is described. In the present embodiment, the cache management unit 45 further stores the data information in the entry in the graphic processors which have been described in connection with the first to fourth embodiments.

FIG. 43 is a conceptual view of the memory 61, and shows states of status flags included in the cache management unit 45. As shown in FIG. 43, the cache management unit 45 stores a thread entry flag TE as a status flag, in addition to the tag flag T, valid flag V, refill flag R, write-back flag W and lock flag L. The thread entry flag TE is a flag indicative of which of the threads relates to the data that is stored in the associated entry of the cache memory. The number of bits of the thread entry flag TE is equal to the number of threads which can be issued at the same time.

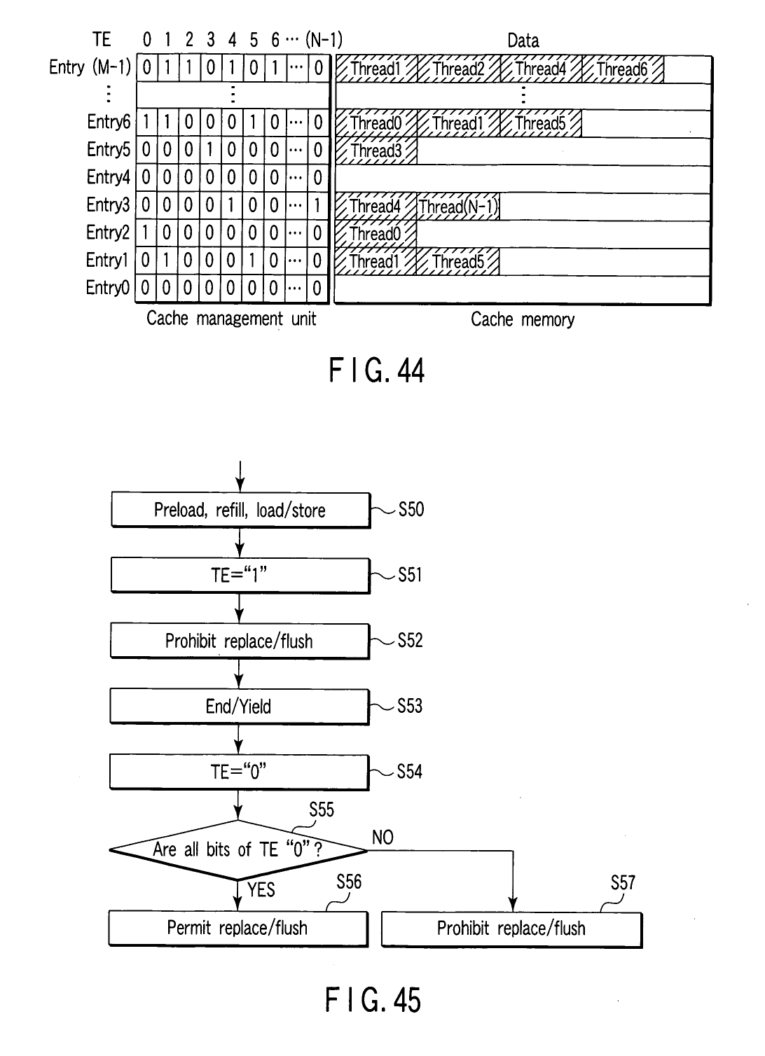

The relationship between the thread entry flag TE and the cache memory 41 is explained with reference to FIG. 44. FIG. 44 is a conceptual view of the thread entry flag TE and the cache memory.

As shown in FIG. 44, the thread entry flag TE has, e.g. N bits. Thus, an N-number of threads, at maximum, are generated at the same time. The N bits correspond to threads 0 to (N−1) from the most significant bit. For example, the entry (M−1) of the cache memory 41 stores data of threads 1, 2, 4 and 6. Accordingly, the bits 1, 2, 4 and 6 of the thread entry flag TE corresponding to the entry 1 of the cache memory 41 is “1”. The entry 4 of the cache memory 41 stores no data. Accordingly, all the bits of the thread entry flag TE corresponding to the entry 4 of the cache memory 41 is “0”.

Next, referring to FIG. 45, a description is given of the write timing of the thread entry flag TE and the state of the entry at this time. To begin with, when the preload instruction, refill instruction or load/store instruction relating to the associated entry are issued (step S50), the bit of the thread entry flag TE, which corresponds to the thread for which the instruction is executed, is set at “1” (step S51). If the thread entry flag TE is set at “1”, either replace or flush (erase) of the data of the associated entry is prohibited (step S52). When the end instruction or yield instruction is executed for the associated thread (step S53), the thread entry flag TE is set at “0” (step S54). When all bits of the thread entry flag TE are “0” (step S55), replace and flush for the associated entry are permitted. On the other hand, in the case where even one of the bits of the thread entry flag TE is “1” (step S55), replace and flush are prohibited.

As has been described above, according to the graphic processor of the fifth embodiment of the invention, the following advantageous effect (6) can be obtained in addition to the advantageous effects (1) to (5) that have been described in connection with the first to fourth embodiments.

(6) The cache memory can efficiently be used (Part 4).

In the graphic processor according to this embodiment, the preload request and refill request of the entry are restricted by the thread entry flag TE. Therefore, the cache entry can efficiently be used, and the performance of the graphic processor can be improved. This advantageous effect is described below in detail.

Data transmission/reception between the cache memory 41 and local memory 13 is basically executed in units of an entry size of the cache memory 41, although the unit of data transmission/reception varies depending on the bus size as a matter of course. The same applies to data erase. Accordingly, in the case where an SRAM or the like is used for the cache memory 41 and thereby the entry size of the cache memory 41 is large, data relating to a plurality of threads is read out into one entry of the cache memory 41.

In this case, even if the execution of the sub-pass is completed with respect to some threads of a certain entry, it is possible that other threads in the same entry may be used later. In other words, even if data relating to some threads becomes needless with the completion of the sub-pass, data relating to other threads in the same entry may later become necessary. Thus, even if the process for some threads is completed, it is inefficient to erase data relating to other threads.

In the present embodiment, the thread entry flag TE is used, thereby prohibiting the replace and write-back (or flush) of data with respect to the entry that stores threads for which the execution of the sub-pass is not completed. This prevents useless erasure of data. Therefore, the entry of the cache memory 41 can efficiently be used, and the performance of the graphic processor can be improved.

The timing at which the thread entry flag TE is asserted may not be after the data is actually replaced in the entry, and may be before the replace of data. Specifically, the thread entry flag TE may be asserted at a stage after the load/store instruction is missed and the refill request is issued and before the replace is executed, or at a stage after the preload request is issued and before the data transfer is executed. In this case, in order to prevent the entry from being destroyed by other threads, the entry to be used is reserved by the thread entry flag TE.

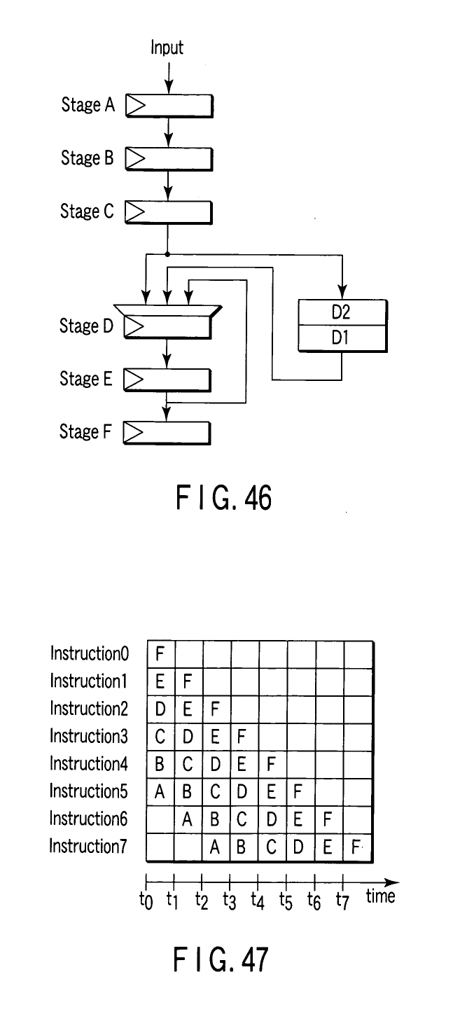

Next, a graphic processor according to a sixth embodiment of the invention is described. This embodiment relates to a data management method in the case where a stage is stalled. FIG. 46 is a circuit diagram illustrating the concept of the data management method according to the present embodiment.

As shown in FIG. 46, assume now that a certain instruction is executed in stages A to F in succession, and the stages A to F perform a pipeline operation. Each stage includes an F/F, and the instruction that reaches each stage is stored in the F/F. Further, the stage D is provided with buffer memories D1 and D2. When a stall has occurred, the buffer memories D1 and D2 store the data of the stage C, and the stage D stores the data of the stage E. When the stall is released and the operation is restarted, the data in the buffer memories D1 and D2 is output to the stage D.

Next, the operation of the stages is described. To begin with, referring to FIG. 47, a description is given of an operation at a normal time when no stall occurs. FIG. 47 is a table showing variations with time of instructions which are executed in the respective stages. Assume now that the instructions to be executed are instructions 0 to 7.

Assume that at time point t0, instructions 0 to 5 are executed by stages F to A, as shown in FIG. 47. In the next cycle (time point t1), the instructions 1 to 5 are executed in the next stages F to B. In addition, a new instruction 6 is input to the stage A and is executed. Since the execution of the instruction 0 is completed at the last stage F at time point t0, the process of the instruction 0 is finished. In this manner, the instructions 0 to 7 are pipeline-processed in the order of stages A to F.

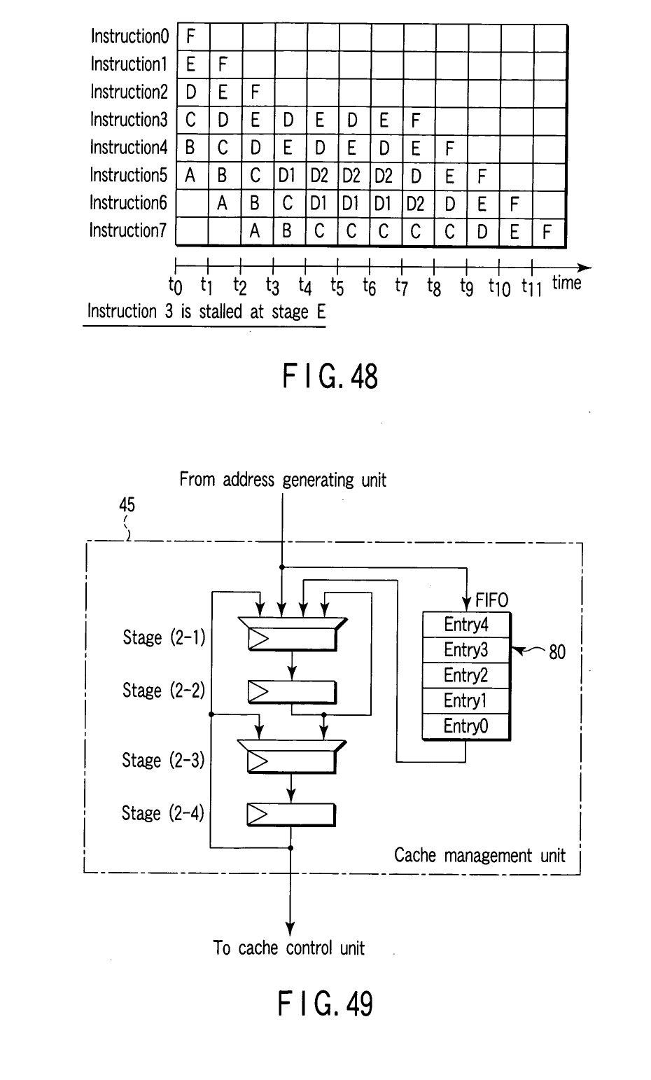

Next, a case in which a stall has occurred is described with reference to FIG. 48. FIG. 48 is also a table showing variations with time of instructions which are executed at the respective stages. For example, a description is given of the case where the instruction 3 is stalled at stage E.

As shown in FIG. 48, the following case is assumed. At time point t0, instructions 0 to 5 are executed at stages F to A. At time point t1, instructions 1 to 6 are executed at stages F to A. A time point t2, instructions 2 to 7 are executed at stages F to A. At time point t3, instruction 3 is stalled at stage E. Then, normally, at time point t3, instructions 3 to 7 are to be executed at stages F to B. However, since the stall has occurred, the instruction 5 which is stored in the stage C at time point t2 is sent to the buffer memory D1, and the instruction 3 which is stored in the stage E at time point t2 is fed back to the stage D.

If the stall continues in the next cycle (time point t4), the instruction 5 which is stored in the buffer memory D1 at time point t3 is sent to the buffer memory D2, the instruction 6 which is stored in the stage C at time point t3 is sent to the buffer memory D1, and the instruction 4 which is stored in the stage E at time point t3 is fed back to the stage D. Subsequently, during the time period up to time point t6 until which the stall continues, the instruction 5 is kept stored in the buffer memory D2 and the instruction 6 is kept stored in the buffer memory D1. The instructions 3 and 4 are looped between the stage D and stage E.

If the stall is released at time t7, the instructions 3 to 5 and 7, which are stored in the stages E and D, the buffer memory D2 and the stage C at time point t6, are executed in the stages F, E, D and C. The instruction 6 which is stored in the buffer memory D1 at time point t6 is sent to the buffer memory D2 at time point t7, and is executed in the stage D at time point t8.

Referring to FIG. 49, a description is given of the case in which the above-described data management method is applied to the graphic processors according to the first to fifth embodiments. FIG. 49 is a circuit diagram of a partial region of the cache management unit 45. As has been described with reference to FIG. 22, when the load instruction is issued, the cache data address signal is delivered to the cache management unit 45 from the address generating unit 40. In addition, as described with reference to FIG. 38, the preload address is delivered at the time of preload.

The cache management unit 45 operates in the second stage, as described with reference to FIG. 11. The second stage includes at least four operation stages (2-1) to (2-4). Specifically, in the stage (2-1), the cache management unit 45 executes the hit determination of the load/store and preload. In the stage (2-2), the cache management unit 45 selects the entries of the refill and preload by using the LRF queue. In the stage (2-3), the stall signal is asserted, for example, when a cache miss has occurred or the hit entry is in the process of the refill operation. At the stage (2-4), the signal is transferred to the cache control unit.

In FIG. 49, a loop path from the stage (2-2) to the stage (2-1) is used when a stall has occurred at the stage (2-2) or stage (2-1). In this state, the stall signal is asserted by the rendering process unit 26.

A loop path from the stage (2-4) to the stage (2-3) is used when a stall has occurred at the stage (2-2) or stage (2-1) in the state in which a stall has occurred at the stage (2-4) or stage (2-3). Thus, in this case, the loop path from the stage (2-2) to stage (2-1) and the loop path from the stage (2-4) to the stage (2-3) become effective.

A loop path from the stage (2-4) to the stage (2-1) is used when a stall has occurred at the stage (2-4) or stage (2-3). In this case, since the stall signal is asserted, the loop path from the stage (2-4) to stage (2-1) is rendered effective by this signal. In addition, if the loop path between the stage (2-2) and stage (2-1) and the loop path from the stage (2-4) to the stage (2-3) are effective, these loop paths are rendered effective even at the timing when the stall signal is asserted.

The buffer memory 80 includes, for example, five entries. The buffer memory 80 stores addresses which are input after the stall signal is asserted. The reason is that after the stall signal is propagated to the third stage (see FIG. 11), the address generating unit 40 stops inputting addresses. Thus, the buffer memory 80 is used in order to keep effective the addresses which are input while the stall is occurring.

As has been described above, according to the graphic processor of the sixth embodiment of the invention, the following advantageous effect (7) can be obtained in addition to the advantageous effects (1) to (6) that have been described in connection with the first to fifth embodiments.

(7) The processing efficiency of the graphic processor after a stall can be improved.

The graphic processor according to the present embodiment includes the buffer memory which stores, when an instruction to be executed is stalled, the instruction in an emergency measure. After the stall is released, the process can be restarted by using the data in the buffer memory. Therefore, the processing efficiency of the graphic processor can be improved. This point is explained below.

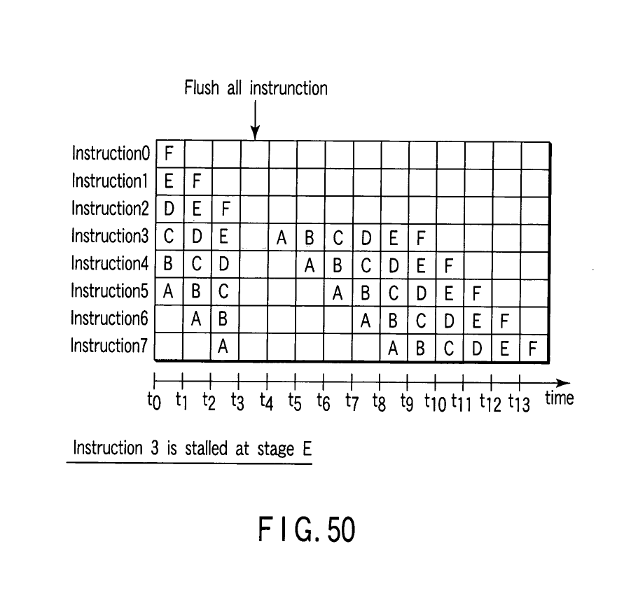

FIG. 50 is a table showing the relationship between the instructions and the stages at the time of executing the instructions in the same manner as in FIG. 47, in the case where the memory buffer is not provided. Assume now that the instruction 3 is stalled at the stage E, like the case of FIG. 48. When a stall has occurred, it is difficult to instantaneously stop the pipeline. In the case of FIG. 50, although it is necessary to store the state of time point t3 at time point t3, the instructions 7 to 4 of the stages A to D overrun to the stages B to E. As a result, although the instruction 3 is stored in the stalled stage E, the instruction 4 of the stage D is input and the instruction 3 is destroyed. In order to avoid this situation, it is necessary to flush all instructions of the stages A to F at time point t3. It is necessary to flush, at least, the instructions of the upstream stages of the stalled stage (stages A to D in the case where the stage E is stalled). However, since all the instructions are flushed, it is necessary to re-input the instructions from the beginning in order to restart the process at time point t4. In this case, the instructions have to be input each time a stall occurs, and the performance of the graphic processor would considerably deteriorate.

According to the structure of the present embodiment, when the stall is released, the process can be restarted by using the data stored in the buffer memory 80. Since there is no need to input the instructions once again, the decrease in performance of the graphic processor can be suppressed. This is effective in such cases that the operation frequency of the graphic processor is high (e.g. several GHz) and the levels of stages are very deep. The reason is that in such cases, several cycles are needed to actually stop the pipeline after the occurrence of a stall is detected.

In particular, in the case of the structure of this embodiment, as shown in FIG. 11, the address signal that is output from the address generating unit 40 reaches the cache memory 41 after the address signal undergoes the second stage including several processing stages. In this way, the levels of stages of the pipeline are deep because it is necessary to wait for the processing in the instruction control unit 25. One pixel shader 24 batch-processes, e.g. (4×4) pixels at a time. In this case, it is the instruction control unit 25 that generates pixels. However, the information, which is delivered from the data sorting unit 20 to the instruction control unit 25, is only data for one pixel, which becomes a representative point, and difference values between other pixels and the representative point. From this information, the instruction control unit 25 generates data of 15 pixels other than the representative point. Thereby, the number of registers which store data can be reduced. Since the cache management unit 45 needs to have a calculation process of the pixel data, the levels of stages of the pipeline become deep, as shown in FIG. 11.

However, even if the levels of stages of the pipeline become deep, the data which is stored in the stage at the time of the stall can be saved in the buffer memory 80 and the data in the buffer memory 80 can be used at the time of restart. Therefore, the deterioration in process efficiency can effectively be suppressed.

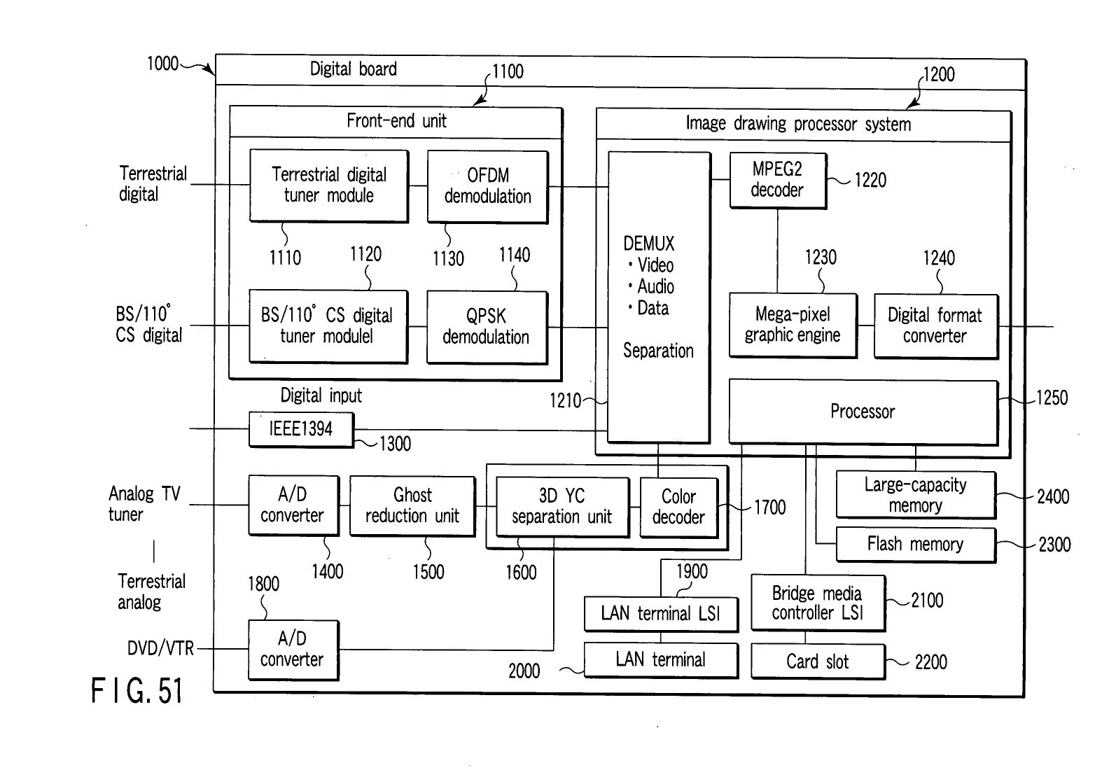

The graphic processor according to the first to sixth embodiments are applicable to, e.g. game machines, home servers, TVs, mobile information terminals, etc. FIG. 51 is a block diagram of a digital board that is provided in a digital TV including the graphic processor according to the first to sixth embodiments. The digital board is employed to control communication information such as video/audio. As is shown in FIG. 51, the digital board 1000 comprises a front-end unit 1100, an image drawing processor system 1200, a digital input unit 1300, A/D converters 1400 and 1800, a ghost reduction unit 1500, a 3D YC separation unit 1600, a color decoder 1700, a LAN process LSI 1900, a LAN terminal 2000, a bridge media controller LSI 2100, a card slot 2200, a flash memory 2300, and a large-capacity memory (e.g. DRAM) 2400. The front-end unit 1100 includes digital tuner modules 1110 and 1120, an OFDM (Orthogonal Frequency Division Multiplex) demodulation unit 1130, and a QPSK (Quadrature Phase Shift Keying) demodulation unit 1140.

The image drawing processor system 1200 comprises a transmission/reception circuit 1210, an MPEG2 decoder 1220, a graphic engine 1230, a digital format converter 1240, and a processor 1250. For example, the graphic engine 1230 and processor 1250 correspond to the graphic processor which has been described in connection with the first to sixth embodiments.

In the above structure, terrestrial digital broadcasting waves, BS (Broadcast Satellite) digital broadcasting waves and 110-degree CS (Communications Satellite) digital broadcasting waves are demodulated by the front-end unit 1100. In addition, terrestrial analog broadcasting waves and DVD/VTR signals are decoded by the 3D YC separation unit 1600 and color decoder 1700. The demodulated/decoded signals are input to the image drawing processor system 1200 and are separated into video, audio and data by the transmission/reception circuit 1210. As regards the video, video information is input to the graphic engine 1230 via the MPEG2 decoder 1220. The graphic engine 1230 then renders an object by the method as described in the embodiments.

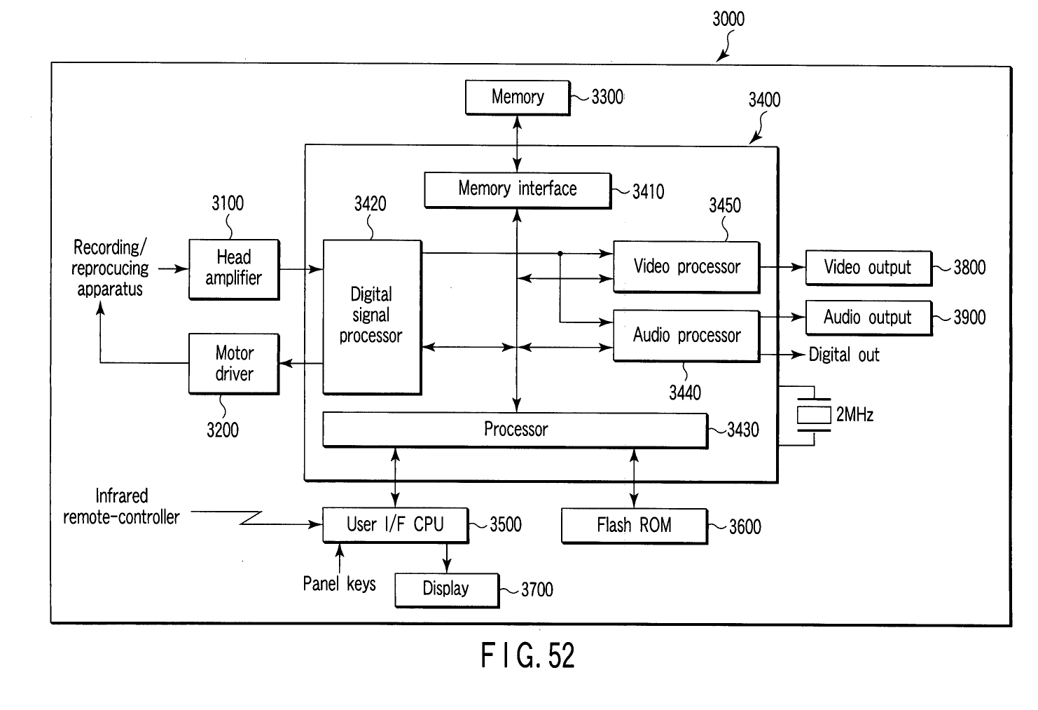

FIG. 52 is a block diagram of a recording/reproducing apparatus that includes the graphic processor according to the first to sixth embodiments. As is shown in FIG. 52, a recording/reproducing apparatus 3000 comprises a head amplifier 3100, a motor driver 3200, a memory 3300, an image information control circuit 3400, a user I/F CPU 3500, a flash memory 3600, a display 3700, a video output unit 3800, and an audio output unit 3900.

The image information control circuit 3400 includes a memory interface 3410, a digital signal processor 3420, a processor 3430, a video processor 3450 and an audio processor 3440. For example, the video processor 3450 and digital signal processor 3420 correspond to the graphic processor which has been described in connection with the first to sixth embodiments.

With the above structure, video data that is read out of the head amplifier 3100 is input to the image information control circuit 3400. Then, graphic information is input from the digital signal processor 3420 to the video processor 3450. The video processor 3450 renders an object by the method as described in the embodiments of the invention.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. A rendering apparatus comprising:
a memory device which stores image data;
a cache memory which executes transmission/reception of the image data to/from the memory device, the cache memory including a plurality of entries, each of which is capable of storing the image data;
a cache control unit which manages data transfer between the memory device and the cache memory and stores information relating to a state of the cache memory, the cache control unit storing, in association with each of the entries, identification information of the image data transferred from the memory device to the entry of the cache memory and transfer information which is indicative of whether the image data is already transferred to the entry or not; and
a rendering process unit which executes image rendering by using the image data in the cache memory.

2. The rendering apparatus according to claim 1, wherein the cache control unit includes a comparison circuit which compares a data access signal to the entry, which is delivered from the rendering process unit, and the identification information, and
the cache control unit rewrites, if a comparison result in the comparison circuit shows disagreement, the identification information corresponding to any one of the entries to a content corresponding to the data access signal, and asserts the transfer information when the image data is transferred from the memory device to the entry.

3. The rendering apparatus according to claim 1, wherein the identification information and the data access signal are address signals relating to the image data which is to be transferred to the associated entry and the image data which has been accessed, respectively.

4. A rendering apparatus comprising:
a memory device which stores image data;
a cache memory which executes transmission/reception of the image data to/from the memory device, the cache memory including a plurality of entries, each of which is capable of storing the image data;
a cache control unit which manages data transfer between the memory device and the cache memory and stores information relating to a state of the cache memory; and
a rendering process unit which executes image rendering by using the image data in the cache memory and causes the cache memory to store the image data that is obtained by the image rendering,
the cache control unit storing, in association with each of the entries, identification information of the image data transferred from the memory device to the entry of the cache memory and data update information which is indicative of whether the image data obtained by the rendering process unit is stored in the entry, and
the cache control unit writing, in a case where the update information corresponding to any of the entries is asserted, the image data, which is present in the entry, into the memory device.

5. The rendering apparatus according to claim 4, further comprising:
a data bus which connects the memory device, the cache memory and the cache control unit; and
a bus control circuit which monitors a use condition of the data bus and outputs the use condition to the cache control unit,
wherein the cache control unit writes the image data, which is present in the entry, into the memory device when the data bus is not in use.

6. The rendering apparatus according to claim 4, wherein the cache memory includes an n (n=a natural number of 2 or more) number of said entries,
the cache control unit includes a counter having a count value corresponding to each of the entries, and a selection circuit which reads out the update information of the entry corresponding to the count value of the counter, and
the cache control unit writes, in a case where the update information selected by the selection circuit is asserted, the image data, which is present in the entry, into the memory device.

7. A rendering apparatus comprising:
a memory device which stores image data;
a cache memory which executes transmission/reception of the image data to/from the memory device;
a rendering process unit which executes image rendering by using the image data in the cache memory;
an information management unit which manages data access information when data access to the cache memory is executed from the rendering process unit;
an information storage unit which stores data information of the image data which is to be preloaded at a time of executing preload; and
a preload address generating unit which calculates, when the preload is executed, an address in the memory device of the image data to be preloaded, by using the data access information managed by the information management unit and the data information stored in the information storage unit.

8. The rendering apparatus according to claim 7, wherein the data access information is information relating to an instruction to be executed for the image data that is to be preloaded, and
the data information includes coordinate information of the image data to be preloaded.

9. A rendering apparatus comprising:
a memory device which stores image data;
a cache memory which executes transmission/reception of the image data to/from the memory device, the cache memory including a plurality of entries, each of which is capable of storing the image data;
a cache control unit which manages data transfer between the memory device and the cache memory and stores information relating to a state of the cache memory; and
a rendering process unit which executes image rendering by using the image data in the cache memory and causes the cache memory to store image data that is obtained,
the cache control unit having a write prohibit flag in association with each of the entries, and restricting, by the write prohibit flag, write of the image data in the entry from the rendering process unit and the memory device.

10. The rendering apparatus according to claim 9, wherein the write prohibit flag includes:
a first state which permits a first transfer process of transferring the image data from the memory device to the entry prior to data access from the rendering process unit, and a second transfer process of transferring the image data from the memory device to the entry by a request from the rendering process unit;
a second state which prohibits the first transfer process and permits the second transfer process; and
a third state which prohibits each of the first transfer process and the second transfer process,
wherein the first state transitions to the second state when the first transfer process is executed, and each of the first state and the second state transitions to the third state when the second transfer process is executed.

11. A rendering apparatus comprising:
a memory device which stores image data;
a cache memory which includes a plurality of entries, each of which is capable of storing the image data, and executes transmission/reception of the image data to/from the memory device in units of a data width of the entry;
a cache control unit which manages data transfer between the memory device and the cache memory and stores information relating to a state of the cache memory; and
a rendering process unit which executes image rendering by using the image data in the cache memory in units of a pixel group which is a set of a plurality of pixels,
the entry having the data width corresponding to an amount of the image data relating to a plurality of said pixel groups, and
the cache control unit including, in association with each of the entries, a pixel group information flag which is indicative of which of the pixel groups is stored in the entry, and restricting write and erase of the image data in the entry in accordance with the pixel group information flag.

12. The rendering apparatus according to claim 11, further comprising:
a pixel group generating device which generates an n (n=a natural number of 2 or more) number of said pixel groups at the same time, and assigns pixel group numbers of 0 to (n−1) to the n-number of pixel groups,
wherein the pixel group information flag has an n-bit data width, with bits of the pixel group information flag corresponding to the pixel group numbers 0 to (n−1), and
an i-th bit of the pixel group information flag is asserted when the image data relating to a pixel group number i (i=0 to (n−1)) is stored in the entry, and the i-th bit of the pixel group information flag is de-asserted when a rendering process of the pixel group of the pixel group number i is executed by the rendering process unit.

13. The rendering apparatus according to claim 12, wherein each of the entries of the cache memory is permitted to erase the stored image data when all bits of the associated pixel group information flag are de-asserted.

14. A rendering apparatus comprising:
a memory device which stores image data;
a cache memory which temporarily stores the image data in the memory device;
a pixel group generating device which generates a pixel group which is a set of a plurality of pixels;
a cache control unit which reads out the image data, which relates to the pixel group generated by the pixel group generating device, into the cache memory; and
a rendering process unit which executes a rendering process of the pixel group generated by the pixel group generating device, by using the image data read out into the cache memory by the cache control unit,
the cache control unit including:
a first process stage in which data relating to the pixel group generated by the pixel group generating device is input;
a second process stage in which the data processed in the first process stage is input;
a third process stage in which the data processed in the second process state is input, the image data being read out into the cache memory in accordance with a process result of the third process stage; and
a buffer memory which stores the data to be input to the first process stage, when a process in any one of the first to third process stages is halted.

15. The rendering apparatus according to claim 14, wherein when the process in any one of the first to third process stages is halted, the data which is stored in the second process stage is output to the first process stage.

16. The rendering apparatus according to claim 14, wherein when the pixel group is generated by the pixel group generating device, the cache control unit determines, at least in the first process stage or the second process stage, whether the image data relating to the pixel group is stored in the cache memory, and
when the image data relating to the pixel group is not stored in the cache memory, the cache control unit issues, in the third process stage, an instruction to transfer the image data from the memory device to the cache memory.

17. The rendering apparatus according to claim 16, wherein in the case where the image data is not stored in the cache memory, the pixel group generating device issues a halt instruction, and
the first to third process stages halt the process in response to the halt instruction.

18. The rendering apparatus according to claim 17, wherein data relating to the pixel group input to the first process state are address signals of the image data, and
when the halt instruction is issued, the address signals are successively stored in the buffer memory, and the address signal stored in the second process stage is fed back to the first process stage.

19. A data transfer method for a rendering apparatus including a memory device which stores image data; a cache memory which executes transmission/reception of the image data to/from the memory device; a cache control unit which includes identification information of the image data in the cache memory and manages data transfer between the memory device and the cache memory; and a rendering process unit which executes image rendering by using the image data in the cache memory, the method comprising:
causing, when data access to the cache memory is executed from the rendering process unit, the cache control unit to compare a content of the data access and the identification information;
causing, when the content of the data access agrees with the identification information, the cache control unit to determine whether the image data corresponding to the data access is stored in the cache memory;
executing the data access if the image data is stored, and halting the data access if the image data is not stored;
causing, when the content of the data access disagrees with the identification information, the cache control unit to rewrite the identification information to a content corresponding to the data access; and
causing, after the identification information is rewritten, the cache control unit to issue a transfer instruction to transfer the image data corresponding to the data access from the memory device to the cache memory.

20. A data transfer method for a rendering apparatus including a memory device which stores image data; a cache memory which includes a plurality of entries and executes transmission/reception of the image data to/from the memory device; a cache control unit which manages data transfer between the memory device and the cache memory and stores information relating to a state of the cache memory; and a rendering process unit which executes image rendering by using the image data in the cache memory, the method comprising:
causing the rending process unit to store new image data, which is obtained by the image rendering, in any one of the entries;
causing, when the new image data is stored in the entry, the cache control unit to assert update information relating to the entry;
causing the cache control unit to detect presence/absence of the entry with respect to which the update information is asserted; and
causing, when the entry with respect to which the update information is asserted is detected, the cache control unit to transfer the image data, which is stored in the entry, to the memory device.
